(19) United States
(12) Patent Application Publication
(10) Pub. No.: US 2016/0274770 A1
(43) Pub. Date: Sep. 22, 2016

(54) Method and System for Platform for Event Management

(71) Applicants: Alfredo Lovati, Bresso (MI) (IT); Sergio Piccini, Martinengo (BG) (IT); Francesco Silanos, Olgiate Olona (VA) (IT); Cristiano Notargiacomo, Milano (MI) (IT); Sandro Locati, Finale Ligure (SV) (IT); Luca Bergonzi, Milano (MI) (IT); Carlo Paradiso, Milano (MI) (IT); Francesco Frugiuele, Milano (MI) (IT); Riccardo Mulas, Castiadas (CA) (IT)

(72) Inventors: Alfredo Lovati, Bresso (MI) (IT); Sergio Piccini, Martinengo (BG) (IT); Francesco Silanos, Olgiate Olona (VA) (IT); Cristiano Notargiacomo, Milano (MI) (IT); Sandro Locati, Finale Ligure (SV) (IT); Luca Bergonzi, Milano (MI) (IT); Carlo Paradiso, Milano (MI) (IT); Francesco Frugiuele, Milano (MI) (IT); Riccardo Mulas, Castiadas (CA) (IT)

(21) Appl. No.: 14/989,790

(22) Filed: Jan. 6, 2016

Related U.S. Application Data
(63) Continuation-in-part of application No. 14/662,185, filed on Mar. 18, 2015.

(51) Int. Cl. G06F 3/0484; G06F 17/30; G06T 11/20; G06F 3/0488; G06F 3/0481

(52) U.S. Cl. CPC G06F 3/04845; G06F 3/0488; G06F 3/04817; G06T 11/203; G06F 17/30241; G06F 17/3087

(57) ABSTRACT

In one example, we describe a Method and System for Dashboard for Event Management. In one example, we describe a method and system for a synoptic dashboard for Public Safety Answering Points, which comprises: a) A dynamic filter criteria definition, tailorable both at PSAP and user level; b) A real-time query & mash-up engine, to combine structured data search and field-tracked feedbacks; and c) An in-place active spreadsheet. Many other applications, situations, and examples are provided in the context of emergency management, optimization, prediction, and analysis. In one example, the table-form interface and platform, called “The Tavolo™”, is the convenient tool to bring all the functionalities and information hub in one place under one umbrella, for the manger to manage all events very efficiently (and reducing possibility of human errors).

### RELATED APPLICATIONS

This case is a CIP of another application pending now, with Ser. No. 14/662,185, titled “Method and System for Dashboard for Event Management”, filed 18 Mar. 2015. All of the teachings of the parent case are incorporated here by reference. The priority date of the parent case (mentioned above) is claimed here.

### BACKGROUND OF THE INVENTION

There are some emergency platforms in the industry, operated by humans, for dispatching the emergency vehicles and police to the proper location. However, the invention and embodiments described here, below, for automatic dispatch, prediction, allocation, and resource analysis, have not been addressed or presented in any prior art. Recently, we have added so many useful and novel features to our system that revolutionize the industry, which are the subjects of the inventions here in this disclosure. One example is the easy-to-use user-interface, in table form, for event management platform, for emergency events, which integrates all needed features and displays them graphically, to inform the user in the best way possible, as we describe below.

### SUMMARY OF THE INVENTION

In one embodiment, we describe a method and system for a synoptic dashboard for Public Safety Answering Points, which comprises: (See, e.g., FIG. 2.)

a. A dynamic filter criteria definition, tailorable both at PSAP and user level

b. A real-time query & mash-up engine, to combine structured data search and field-tracked feedbacks

c. An in-place active spreadsheet

In one embodiment, the filter criteria definition tool allows users to setup complex queries on almost all synopsis related information. (See, e.g., FIG. 3.) The definition tool is system-wide tailorable to the specific needs of each Command & Control Room, and allows a user-level customization bound to his/her roaming application profile. Moreover, it includes context aware optimizations, e.g., for avoiding the query engine from gathering data and requiring a mandatory filter criteria, if the expected returned data set may be too big.

In one embodiment, the real-time query & mash-up engine provides the Command & Control Room users with a constantly updated synthesis of events and dispatches that have not been archived yet. (See, e.g., FIG. 4.) Both events and their related first responders' dispatches are displayed with all the relevant information collected throughout the Call Taking, Mission/Activity Dispatching, and Tracking processes. Besides querying and dashboarding capabilities upon the managed information, our system/platform, called “emma”, distinguishes itself by the unique capability of providing, directly within the dashboard, real-time field-tracked data, mash them up with the standard managed information, and using it to infer the whole process status, rather than only the status of a specific mission or activity. (See, e.g., FIG. 5.) In addition, the result set presentation is system-wide tailorable, specially in terms of supported kinds of events and missions/activities, which give emma the ability to support almost all businesses having a PSAP involved, with customizable iconography, for clear, simple, powerful, and context-aware representations. (See, e.g., FIG. 6.) Each user may also set up personalized rendering preferences, like column orders or default sorting, and bind them to his/her roaming application profile.

In one embodiment, the result set shown by the query & mash-up engine, besides its customization capabilities, includes natively advanced spreadsheet functionalities, e.g., in-place filtering, grouping, and pivoting. This way the need for off-application spreadsheet process, by exporting the result set, is sensibly reduced, even if it is still available. (See, e.g., FIG. 7.) Furthermore, the spreadsheet is not only a data presentation tool, but a real active console including functionalities such as: access to the selected event or dispatching detail, print the selected detail, send map panning commands to the GIS display related to the selected detail's localization, send show/hide commands to the GIS display related to the a dynamic layer of all the involved resources related to the result set, and transfer the incident record to another Command & Control Room, via any of the most popular protocols (e.g. CAP protocol). (See, e.g., FIG. 8.)

In one embodiment, the table-form interface and platform, called “The Tavolo™”, is the convenient tool to bring all the functionalities and information hub in one place under one umbrella, for the manger to manage all events very efficiently (and reducing possibility of human errors).

### BRIEF DESCRIPTION OF THE DRAWINGS

FIG. 1 is for one embodiment, as an example, for our system, with allocation module.

FIG. 2 is for one embodiment, as an example, for our system, with dashboard module.

FIG. 3 is for one embodiment, as an example, for our system, with command & control room module.

FIG. 4 is for one embodiment, as an example, for our system, with real time query & mash-up engine module.

FIG. 5 is for one embodiment, as an example, for our system, with whole process status module.

FIG. 6 is for one embodiment, as an example, for our system, with sorting module.

FIG. 7 is for one embodiment, as an example, for our system, with customization module.

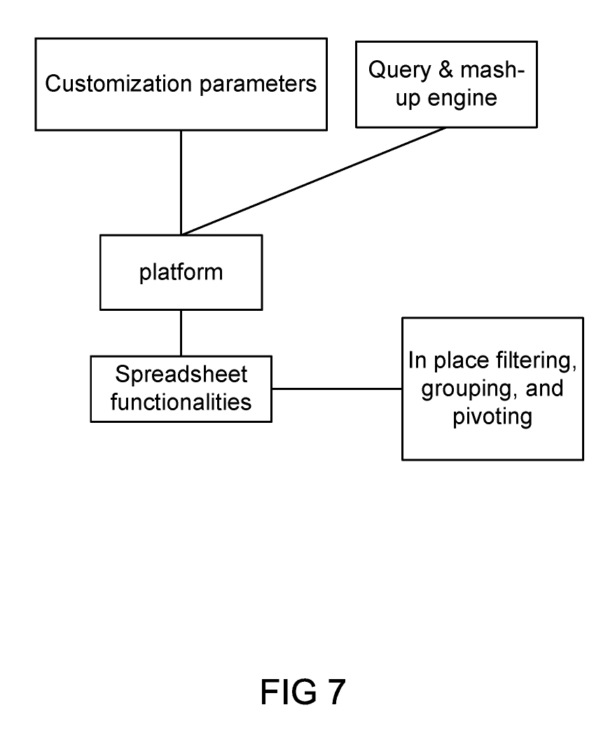

FIG. 8 is for one embodiment, as an example, for our system, with dynamic layer module.

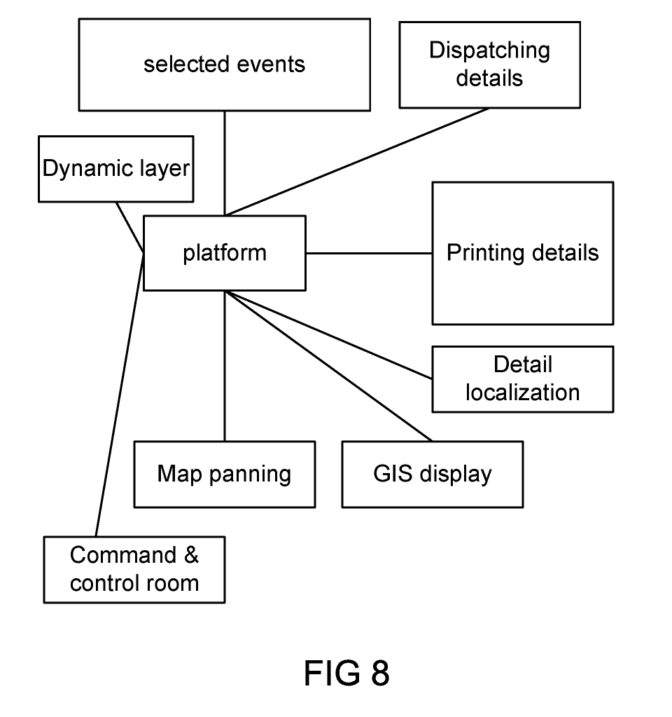

FIG. 9 is for one embodiment, as an example, for our system, with analytics module.

FIG. 10 is for one embodiment, as an example, for our system, with telephony module.

FIG. 11 is for one embodiment, as an example, for our system, with predictive module.

FIG. 12 is for one embodiment, as an example, for our system, with emergency management module.

FIG. 13 is for one embodiment, as an example, for our system, with health care module.

FIG. 14 is for one embodiment, as an example, for our system, with call tracking client module.

FIG. 15 is for one embodiment, as an example, for our system, with data input module.

FIG. 16 is for one embodiment, as an example, for our system, with dispatching module.

FIG. 17 is for one embodiment, as an example, for our system, with tracking module.

FIG. 18 is for one embodiment, as an example, for our system, with data output module.

FIG. 19 is for one embodiment, as an example, for our system, with predictive module.

FIG. 20 is for one embodiment, as an example, for our system, with maxi-emergency module.

FIG. 21 is for one embodiment, as an example, for our system, with color code module.

FIG. 22 is for one embodiment, as an example, for our system, with urgency module.

FIG. 23 is for one embodiment, as an example, for our system, with filtered search module.

FIG. 24 is for one embodiment, as an example, for our system, with optimizer module.

FIG. 25 is for one embodiment, as an example, for our system, with map modules.

FIG. 26 is for one embodiment, as an example, for our system, with distance module.

FIG. 27 is for one embodiment, as an example, for our system, with order urgency module.

FIG. 28 is for one embodiment, as an example, for our system, with re-assign module.

FIG. 29 is for one embodiment, as an example, for our system, with intersection and union modules on sets or lists.

FIG. 30 is for one embodiment, as an example, for our platform and device, with various buttons and functions, plus display and options.

FIG. 31 is for one embodiment, as an example, for our platform and device, with one sub-window.

FIG. 32 is for one embodiment, as an example, for our platform and device, with multiple sub-windows.

FIG. 33 is for one embodiment, as an example, for our platform and device, with hand and finger gestures for user input.

FIG. 34 is for one embodiment, as an example, for our platform and device, with various functionalities on the screen.

FIG. 35 is for one embodiment, as an example, for our platform and device, with a circle region defined on screen.

FIG. 36 is for one embodiment, as an example, for our platform and device, with a polygon region defined on screen.

FIG. 37 is for one embodiment, as an example, for our platform and device, with a region defined on screen.

FIG. 38 is for one embodiment, as an example, for our platform and device, with a perpendicular distance measured on screen.

FIG. 39 is for one embodiment, as an example, for our platform and device, with a perpendicular distance measured and ordered for various vehicles.

FIG. 40 is for one embodiment, as an example, for our system, with components of our platform for public safety.

FIG. 41 is for one embodiment, as an example, for our platform and system, with distance optimizer.

### DETAILED DESCRIPTION OF THE PREFERRED EMBODIMENTS

In one embodiment, we describe a method and system for a synoptic dashboard for Public Safety Answering Points. In one embodiment, “emma” is our system and platform (Beta 80 Group's Emergency Management software platform). “emma” provides PSAPs and First Responders with all the features required to react at the best to any type of emergency call. emma is the most complete software suite for PSAP available on the international market. emma has ultra-high level of customization, easy integration with multiple devices and vendors, and effective customer support. emma has been the No. 1 Italian emergency management platform, deployed in 60 installations on Italian territory, Europe, South America, Africa, Middle East and Asia, serving more than 25 million people. Via emma, more than 6 million emergency calls are managed every single year. For example, emma is the chosen platform for the Emergency Agency of the Milan area (AREU) where more than 9 million people live. Milan's main PSAP has more than 40 operators, and gets more than 2 million calls per year, proving to be the biggest Ambulance Services' PSAP in Europe.

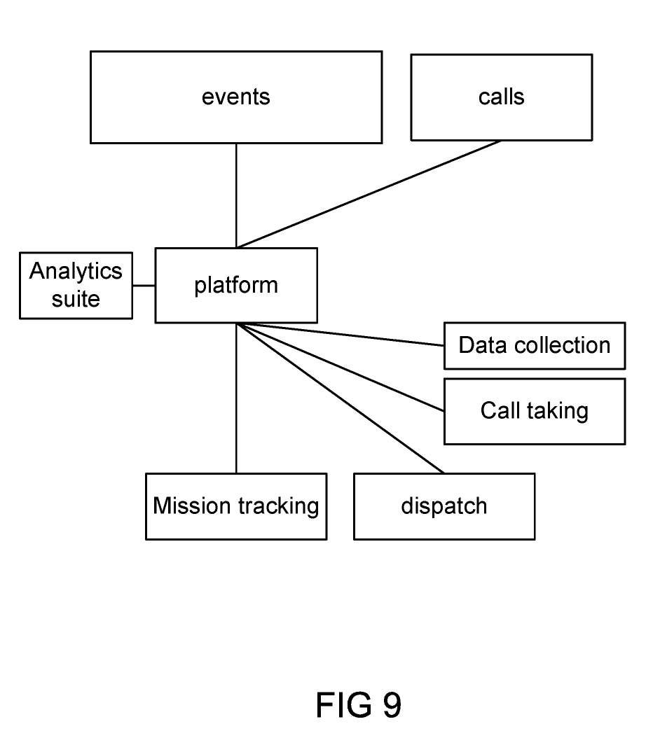

emma has been a unique platform in managing efficiently and effectively a growing number of calls and type of events, evolving by design to suit PSAP changing needs. emma covers and supports all the tasks and activities involved in a modern PSAP's management, from Call Taking to Dispatch, Mission Tracking, and a full Data Collection and Analytics suite. (See, e.g., FIG. 9.) Plus, emma is fully NG-911-compliant.

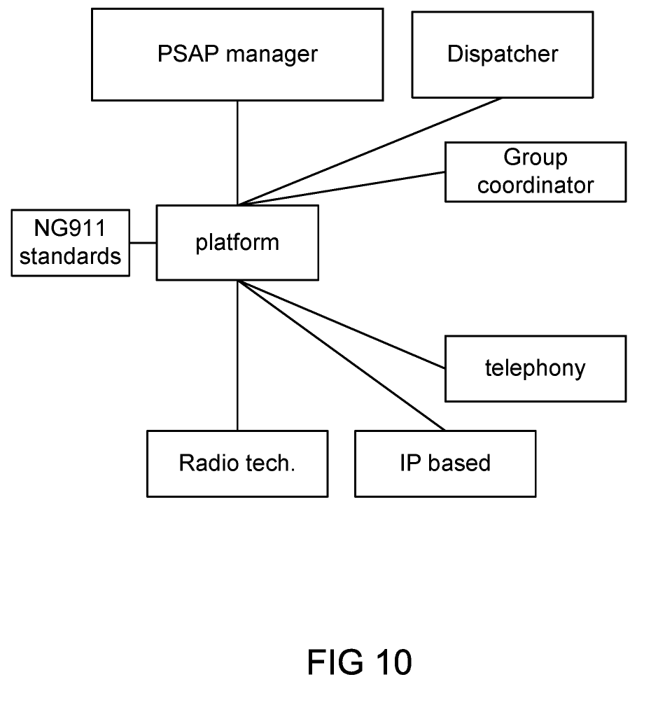

emma provides a comprehensive solution for Call Takers, Dispatchers, and Group Coordinators, providing PSAP's managers with the most accurate and complete solution available on the market. It is far beyond NG911 standards. emma makes call-taking fast and accurate, and can be integrated with any choice of Telephony or IP-Based Communication technology. It manages any kind of radio technology, too. (See, e.g., FIG. 10.)

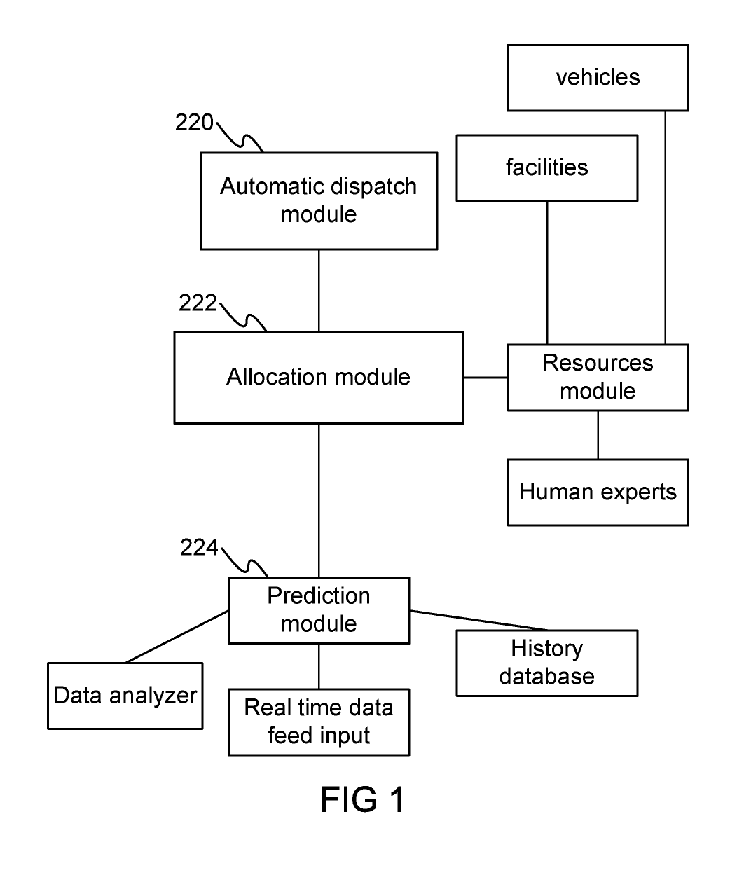

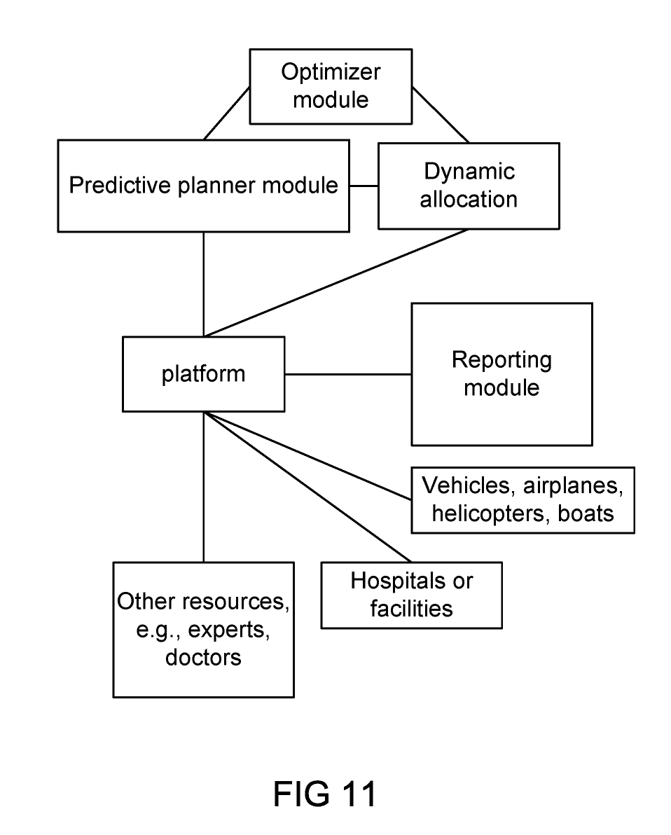

emma can be completely customized to fit any process of Dispatching, letting operators follow their own protocols and procedures. It also automatically tracks every single step of the custom designed process. This means that it is easy to learn, too. emma has the following features:
a deep reporting platform second to none in the emergency management industry, (See, e.g., FIG. 11.)
a hyper-long list of technology connectors, and
complementary applications such as a predictive planner to dynamically allocate vehicles and other resources on the map. (See, e.g., FIG. 1.)

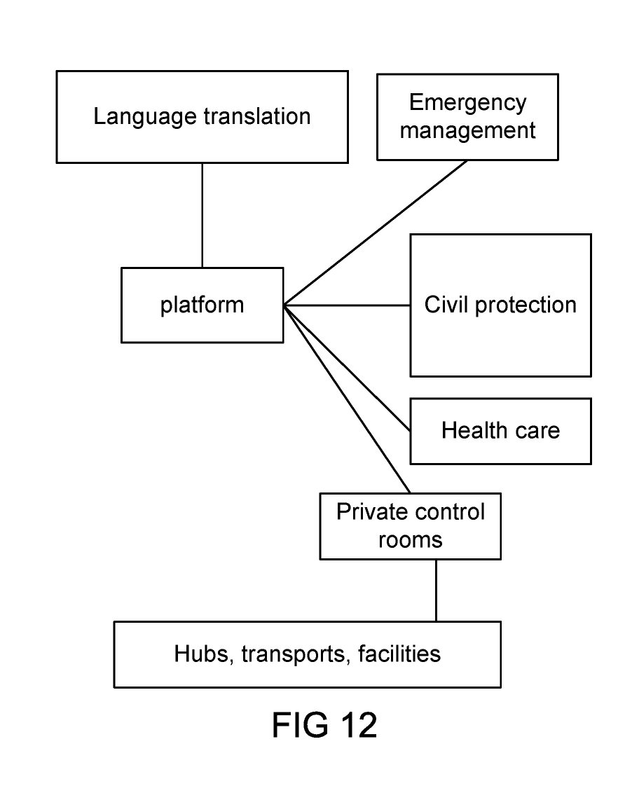

Beta 80 Group serves more than 60 PSAPs in Europe, Latin America, the Mid-East, Africa and Asia. A team of 400+ professionals work for Beta 80, and a 24×7 multi-lingual Single Point of Contact takes care of its customers in any country. The family of products include: (See, e.g., FIG. 12.)

Emergency management
9-1-1
Emergency medical services
Firefighters

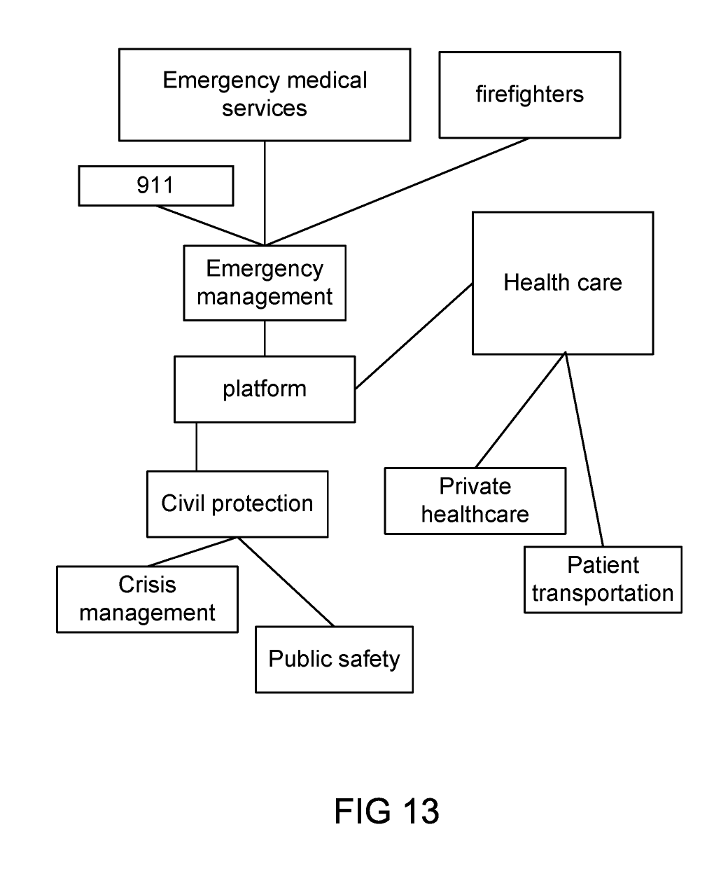

Civil protection (See, e.g., FIG. 13.)
Crisis management
Public safety and homeland security

Healthcare
Private healthcare
Patient transportation services

Private control rooms
Hubs, transports, exhibition centers, oil & gas facilities

Thus, emma is the most complete solution in the PSAP industry. emma is fully compliant with NG 9-1-1 standards. emma is completely adaptable to any PSAP specific process. emma is way less expensive than any other comparable CT/CAD software in the market. emma has a proven and growing track of satisfied customers. We have achieved this result constantly focusing on our 3C Mantra: affordable Cost, Customization & Customer Support.

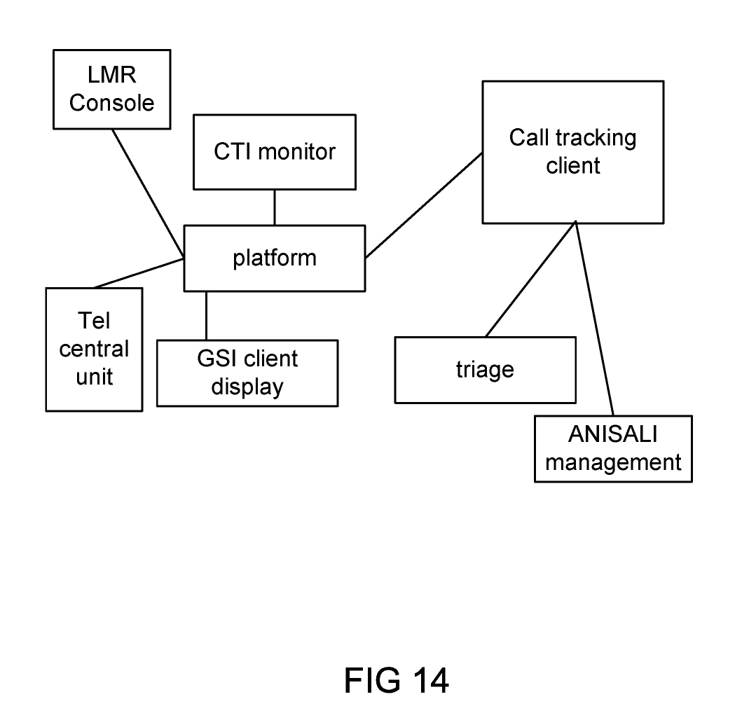

Appendix 1 shows Beta 80 emma architecture high-level design, as an example. More information is available at: www.Beta80group.it, our web site. In Appendix 1, page 2, on the top figure, we show a number of displays that can be increased according to the PSAP requirements. On the left, we show a Call Tracking Client (CTI) monitor. In the middle, we have Call Tracking Client (triage and ANISALI management) and CAD client. On the right, we have GIS client (third party) display. On the far right, we have LMR/TETRA console. On front, we have a tel. set desktop unit or central unit. (See, e.g., FIG. 14.)

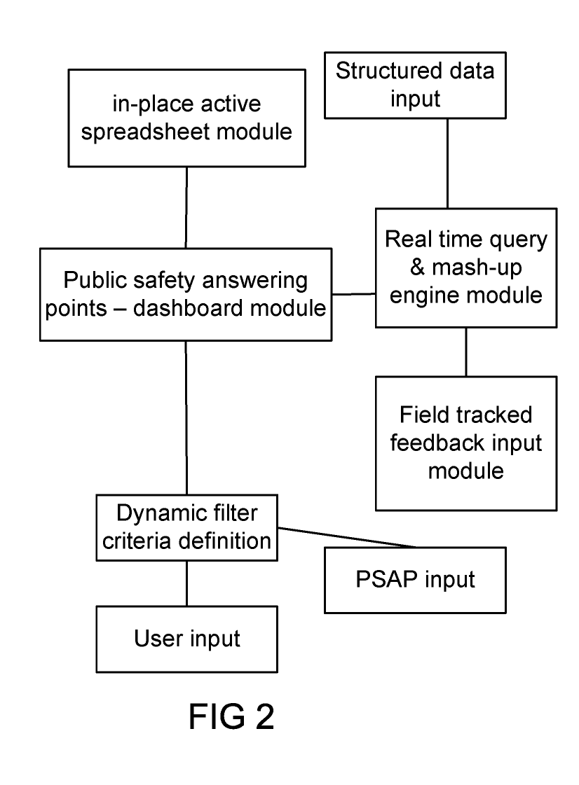

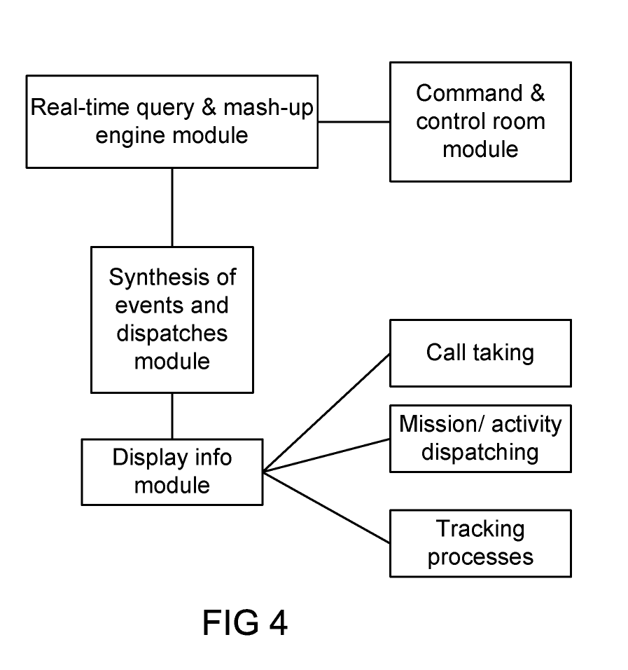

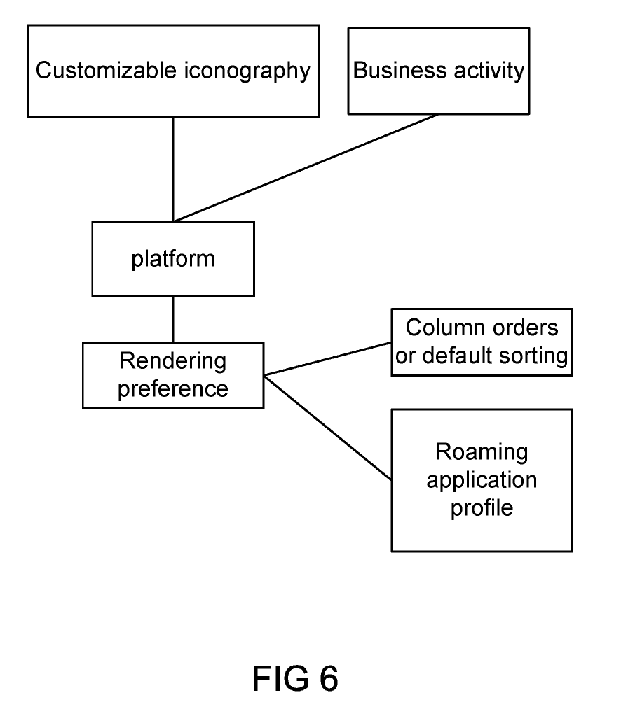

Appendix 1 also shows other embodiments:
FIG. 1: emma telephone bar client.
FIG. 2: emma emergency management client: event record (Call Taking).
FIG. 1: Regola ORIENTAE GIS viewer. It provides an interface which is developed on Google Chrome.
FIG. 4: emma emergency management client: mission tracking (Call Dispatch).
FIG. 2: emma emergency management client: patient form. Patient information is distributed among different TABs.
FIG. 6: emma emergency management client: synoptic table of “live” events. The icons and the numbers represent the nature of the event and the statuses of the missions associated with it (e.g. ambulance directed to the hospital). The statuses can be automatically updated basing on the data coming from on duty vehicles via radio or IP based channels.

Appendix 2 page 1 shows an example of our system: what emma does. emma covers and supports all the tasks and activities involved in a modern PSAP's management, from Call Taking to Dispatch, Mission Tracking, and a full Data Collection and Analytics suite. Plus, emma is fully NG-911 compliant. Appendix 2 page 1 also shows an example of details of our system:

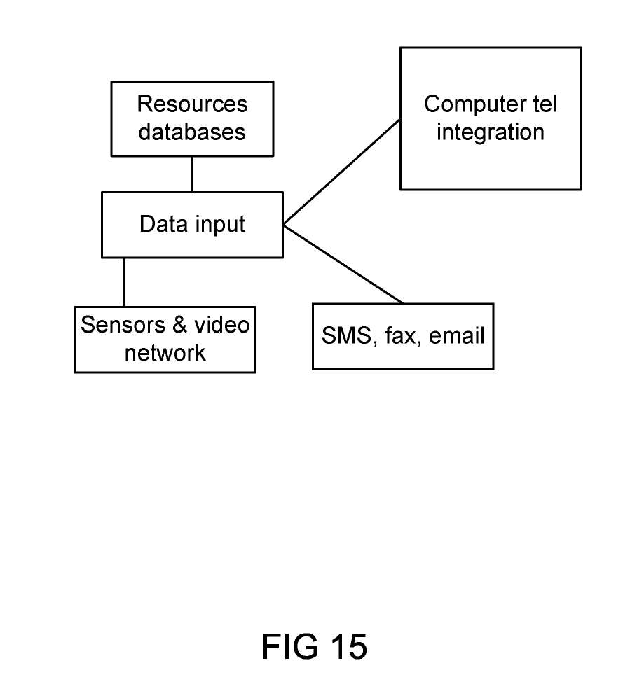

Data input: (See, e.g., FIG. 15.)
Computer telephone integration
SMS, fax, emails
Sensors and video networks
Resources databases

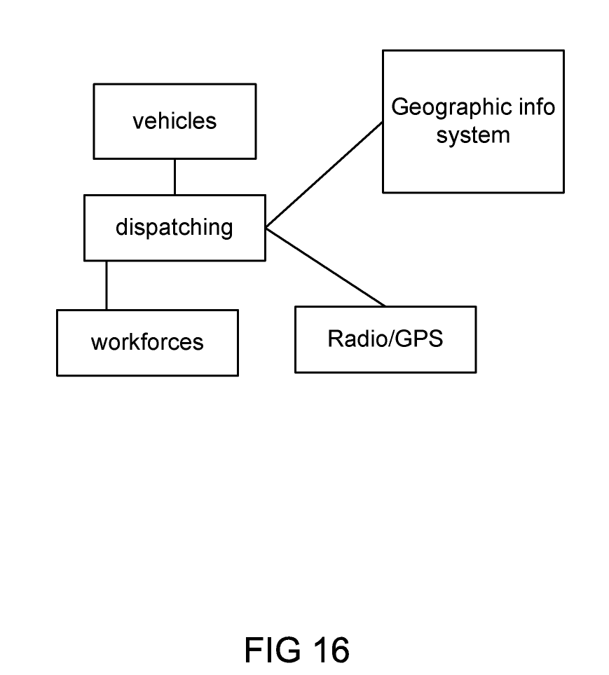

Dispatching: (See, e.g., FIG. 16.)
Geographic information system
Radio/GPS
Workforces and vehicles

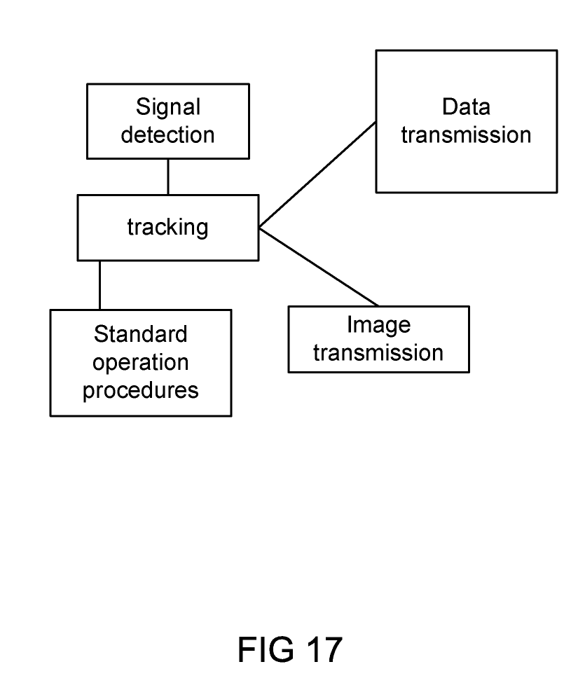

Tracking: (See, e.g., FIG. 17.)
Signal detection
Data transmission
Image transmission
Standard operation procedures

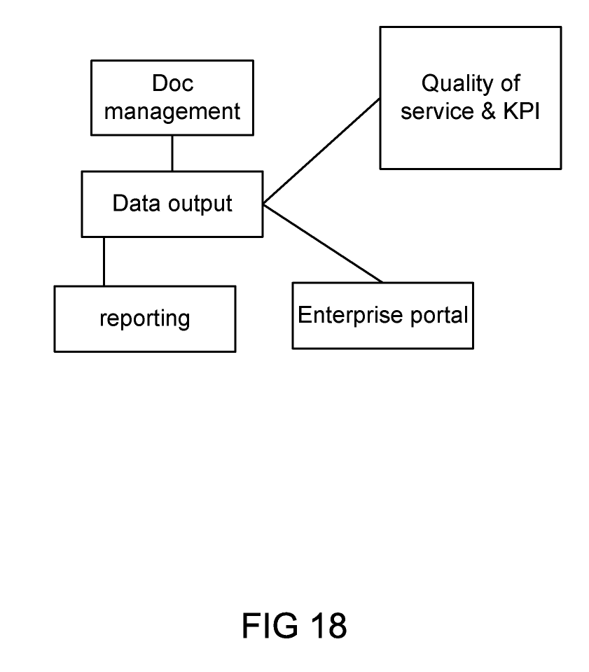

Data output: (See, e.g., FIG. 18.)
Quality of service and KPI
Document management
Enterprise portal
Reporting

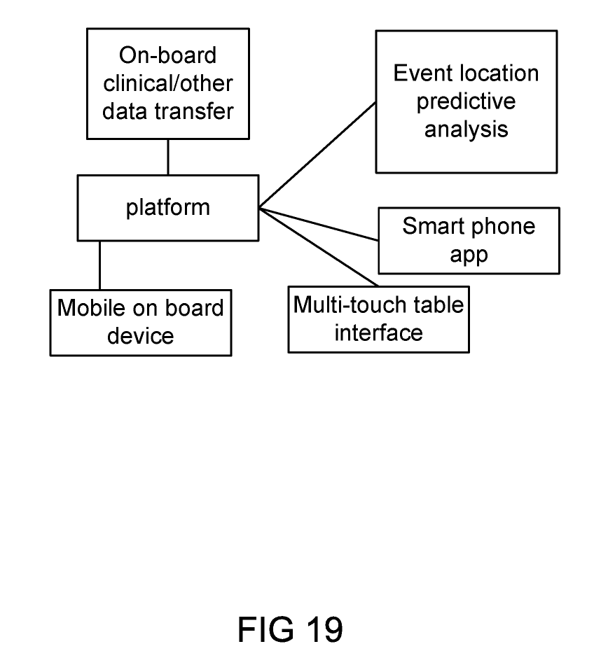

And other features: (See, e.g., FIG. 19.)
On-board clinical/other data transfer
Event location predictive analysis
Mobile on-board devices
Multi-touch table interface
Smart phone App

Appendix 2 page 2 shows an example of what you see as a dispatcher. On the left, we have a monitor for all the status and data for various actors in the scene and environment. On the right, we have a display for the map, locations, directions, points-of-interest, and scale for map, as well as menu for the functions for the map, e.g., markers on the map and highlighter for the route on the map.

In one embodiment, we have BETA 80 EMMA architecture, as high level design. Emma is composed of a number of software modules. emma can be installed on any commercial hardware (servers or storage). emma can be accessed in two different ways:
client access: full featured access, typically used from inside the PSAP. A common operator position is made of three displays. The first monitor is used for the phone bar client, the second for the emergency management client, and the third for the GIS viewer.
web access (single display): it grants Microsoft IE access to a subset of features, restricted as “read-only” or “read-write”, depending of the particular user, to address the possible needs of PSAP external entities/agencies that are not operationally involved in the emergency management process (e.g., private associations or charities which may lend emergency vehicles to the EMS Agency).

### Emma Macro-Features Walk-Through:

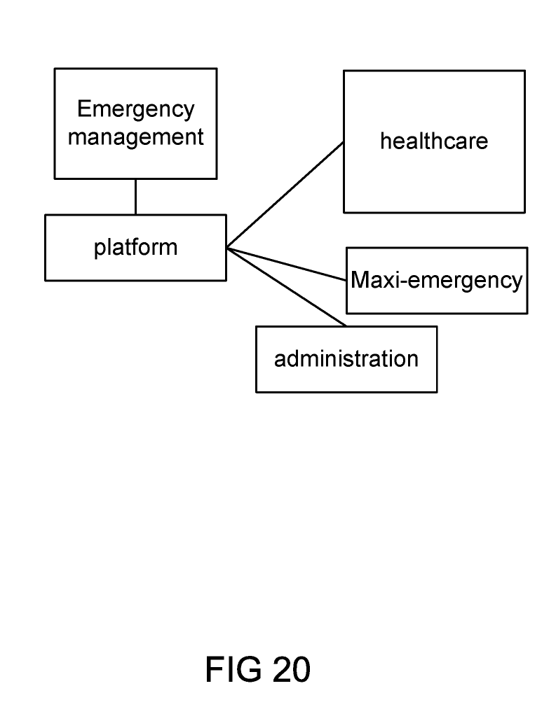

Depending on the particular mix of modules that will be activated (i.e. licensed), the PSAP is provided with the following features: (See, e.g., FIG. 20.)

Emergency Management:
call taking (phone calls, SMS) assisted by GIS and automatic caller location
call dispatching assisted by GIS and with complete interconnection with all the communications systems in place (radio, AVL, phone)
patient record management from within the PSAP or jointly with the staff on the ground (emma mobile)
remote web access (read-only or read-write)
emergency vehicles location dynamic prediction: a tool to dynamically forecast the optimal emergency vehicles positioning, balancing time responsiveness and the actual number of available resources on the ground
“SOS app” based distress call management (iOS, Android, Windows)
car crash automatic distress call support (emergency calls sent automatically by cars and/or triggered manually by people in the car in case of a crash)

Healthcare:
non-emergency transportations (inter-hospitals patient taxiing, organs transports, etc.): scheduling and accounting
after-hours medical services: non-emergency services provided during GPs off-shift time periods (night, bank holidays, etc.)

Maxi-Emergency:
event manager and crisis planning management: definition of the processes and orchestration/prioritization of activities during a crisis event occurrence (e.g., flood, earthquake, and tornado)
remote web access (as previously described)
first responders' zero hour alerting procedures: on a per event/per location occurrence, a very specific set of skilled first responders can be immediately alerted via different means of communications (phone call, SMS, fax, etc.)
situation room touch-table

Administration:
Data warehouse capabilities for the production of customized reports and statistics
Customer self-provisioning tool
Accounting

### Emma Package Building Blocks:

The following table depicts the relevant details of emma modules that contributes to make up the application framework for the specific PSAP:

TABLE 1
The emma modules, as one example:

| Software module | Technology | Notes |
|---|---|---|
| emma | Third party | It represents the very core of emma; |
| Database | Database | the structure of the DB, meaning the |
| | (SAP Sybase, | schemas and the relationships between |
| | Microsoft | them have completely been designed, |
| | SQL, Oracle) /w | engineered and developed by Beta 80. |
| | Beta 80 | The DB is accessed by emma |
| | development | emergency management client. |
| emma CTI | Beta 80 | Completely developed by Beta 80, it |
| | | performs the interworking between |
| | | emma and the telephonic system (i.e. |
| | | PBX); the protocols and software |
| | | interfaces upon which it works are |
| | | provided by the specific PBX Vendor. |
| | | Emma requires a specific CTI module |
| | | for every PBX technology it must |
| | | inter-work with. |
| | | CTI module is accessed by a specific |
| | | emma client (the phone bar client). |
| | | A CTI module “light” version exists |
| | | which is based on a client/client |
| | | relationship where the phone bar |
| | | client is supplied by the PBX Vendor |
| | | and interconnected with emma |
| | | emergency management client (which |
| | | needs specific Beta 80 developed |
| | | plug-ins). |
| emma GIS | Third Party /w | The GIS viewer performs the |
| viewer | Beta 80 | geographic contextualization of the |
| | software | occurring emergency events. This |
| | integration | module is integrated with emma via |
| | | specific open APIs provided by the |
| | | Vendor. When it's viable, Beta 80 |
| | | suggests Regola ORIENTAE |
| | | technology, although emma is open to |
| | | be integrated with any other GIS |
| | | product as long as it provides the |
| | | relevant open APIs. |
| emma Call | Beta 80 | Completely developed by Beta 80, it |
| Logger | | performs the interworking between |
| | | emma and the Call Logger/Call |
| | | Recorder. As in the case with the CTI, |
| | | the CL module leverages on open |
| | | APIs supplied by the CL Vendor. |
| emma radio | Beta 80 | It performs the inter-working between |
| | | emma and the local LMR system. It's |
| | | been completely developed by Beta |
| | | 80; any LMR (analog or digital) or |
| | | Tetra technology can be integrated as |
| | | long as its server component provides |
| | | the relevant open APIs. |
| emma Fax | Beta 80 | This module makes it possible for |
| Server | | emma to integrate with a specific third |
| | | party fax server technology (ZetaFax) |
| | | which is sold as a separate solution |
| | | component. It's been completely |
| | | developed by Beta 80. |
| emma SMS | Beta 80 | It provides emma with the capability |
| | | to interface SMS Providers; it allows |
| | | PSAP operators to manage distress |
| | | calls carried out via SMS (e.g. from |
| | | hearing impaired people). It's been |
| | | completely developed by Beta 80. |
| emma DWH | Third Party /w | Beta 80 provides data export to |
| | Beta 80 | external DWH applications via |
| | software | software connectors (the so-called |
| | integration | ETLs) completely developed by |
| | | Beta 80. |
| | | The choice of the particular DWH |
| | | applications (e.g. MicroStrategy, |
| | | SAS) typically depends on the |
| | | PSAP/Public Safety Agency. |
| emma mobile | Beta 80 | emma access from “on the ground” |
| | | staff (e.g. via 3 G/4 G tablets) for |
| | | vertical applications. Some examples: |
| | | patient clinical record, on-board |
| | | ECGs, and Automated External |
| | | Defibrillators data on-the-go |
| | | transmission. It's been completely |
| | | developed by Beta 80. |
| emma web | Beta 80 | This module allows access to emma |
| | | via Microsoft Internet Explorer. It's |
| | | been completely developed by |
| | | Beta80. |
| emma non- | Beta 80 | It's been completely developed by |
| emergency | | Beta 80. |
| transports | | |
| emma | Beta 80 | This module can be used when the |
| administrative | | PSAP or the Agency in control of the |
| module | | PSAP is in charge of refunding |
| | | external entities. It's been completely |
| | | developed by Beta80. |
| After-hour | Beta 80 | It's been completely developed by |
| medical services | | Beta80. |
| Fleet vehicles | Beta 80 | It's been completely developed by |
| positioning | | Beta80. |
| dynamic forecast | | |
| emma inter- | Beta 80 | Those are typically customized |
| PSAP | | modules developed by Beta 80, on a |
| communications | | “per customer” basis. |
| emma external | Beta 80 | |
| agencies | | |
| communications | | |
| (e.g. ALI DB, | | |
| hospitals bed | | |
| count) | | |
| emma external | Beta 80 | |
| PSAP' s | | |
| elements | | |
| communications | | |
| (e.g. AVL | | |
| systems, DB s) | | |

### Emma Graphical User Interfaces (Referring to Appendix 1, FIGS. 1-6):

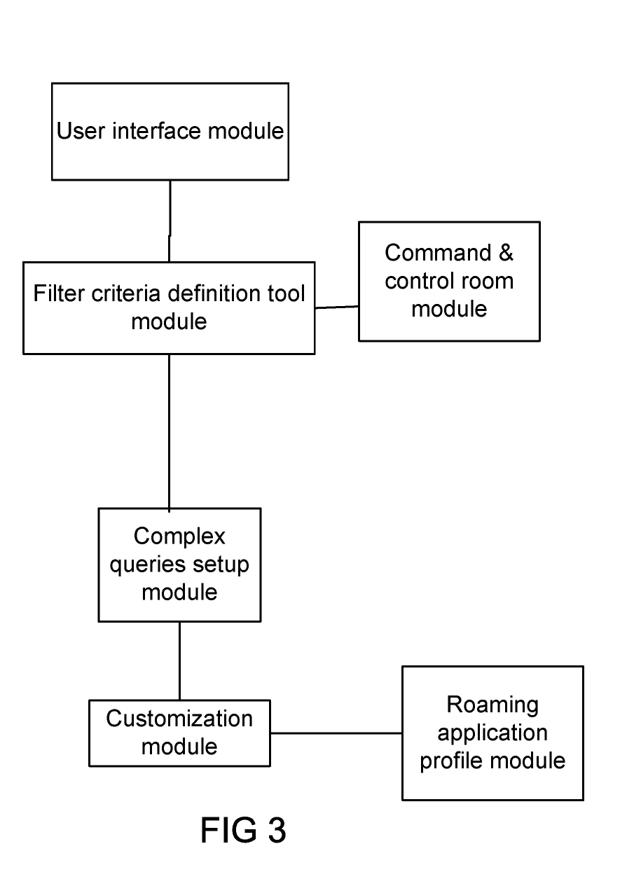

The FIG. 1 of Appendix 1 has been taken from a demo installation (as one embodiment). Apart from minor changes due to customization requests, the GUIs of the demo environment are exactly the same as those that appear in real EM control rooms. FIG. 2 shows the emma emergency management client: event record (Call Taking). FIG. 3 shows the Regola ORIENTAE GIS viewer. It provides an interface which is developed on Google Chrome. FIG. 4 shows the emma emergency management client: mission tracking (Call Dispatch).

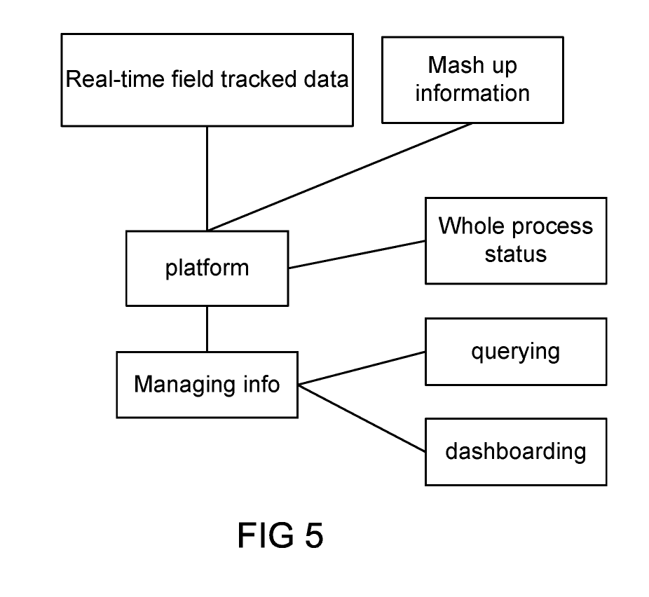

FIG. 5 shows the emma emergency management client: patient form. Patient information is distributed among different TABs. FIG. 6 shows the emma emergency management client: synoptic table of “live” events. The icons and the numbers represent the nature of the event and the statuses of the missions associated with it (e.g. ambulance directed to the hospital). The statuses can be automatically updated basing on the data coming from on duty vehicles via radio or IP based channels.

We are using the following acronyms, for these components:
API—Application Programming Interface
AVL—Automatic Vehicle Location
DB—Database
CL—Call Logger
CTI—Computer Telephony Interface
DWH—Data Warehouse
EM—Emergency Management
ETL—Extract, Transform, Load
GIS—Geographic Information System
GP—General Practitioner
IE—Internet Explorer
LMR—Land Mobile Radio

### Emma Synoptic Dashboard:

emma incidents synoptic dashboard (as one embodiment) provides the PSAP with a constantly updated synthesis of incidents and dispatches that have not been archived, yet. Both incidents and their related first responders dispatches are displayed with all the relevant information collected by the PSAP Operator, via emma Call Taking, Mission Dispatch, and Tracking application modules. Data coming from first responders and transmitted directly from the field are automatically updated according to the refresh frequency chosen by the Customer.

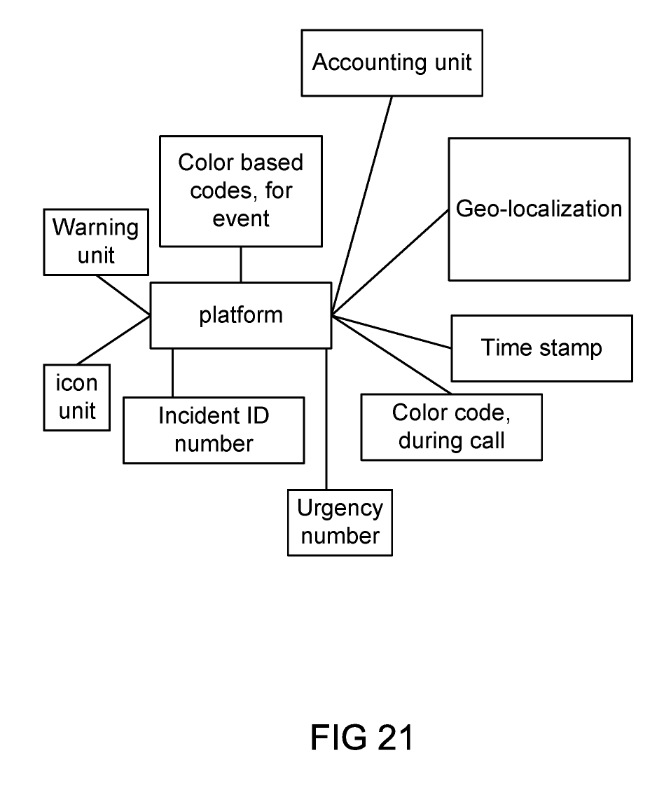

Within the dashboard, each incident is detailed as follows (as one embodiment): (See, e.g., FIG. 21.)

1. Color-based code, indicating the nature of the event (EMS, Police, Fire, etc.); these icons can be customized according to PSAP's policies

2. geo-localization of the incident

3. timestamp (date/hour) of the incident recording

4. Color-code assigned to the incident during the call taking phase (i.e., red, yellow, green, white, etc.)

5. incident's unique ID; this information is also automatically sent to the call logger, as part of the metadata attached to audio recording files

6. incident alphanumerical code (e.g., armed robbery); this field is completely customizable according to PSAP's policies

7. PSAP Operator who has recorded the incident

8. Flag icon to indicate that other Agencies have been alerted or informed about the occurring incident

9. For EMS implementation, icon representing involved: patients with/without real time available EKGs; whether the patient has particular conditions (“frail” patient), to watch for specifically

10. Icon representing content attached to the event record, for example, pre-arrival protocol documents related to the specific event

11. a warning icon, suggesting that an alarm has been triggered for the incident record (e.g., the event record has not generated any dispatch). The trigger thresholds (as incident classification, idle time, etc.) are configurable according to the PSAP preferences or needs.

Depending on its nature, an incident might bring about no dispatch (e.g. prank call), one dispatch or a number of them. In the latter case, all the dispatches associated with a specific incident are properly aligned in order to grant an easy-to-read graphical representation.

Within the dashboard, dispatch details encompass the following (as one embodiment):

1. timestamp (date/hour) of the dispatch

2. PSAP Operator who has performed the dispatch

3. dispatch unique ID

4. emergency resource ID (e.g. vehicle, helicopter, vessel) involved in the dispatch

5. mission status icons and timestamps, which are automatically updated according to messages coming from the first responders on the field (messages might be sent from VHF, UHF, Tetra radio systems, or 3G/4G systems). Both icons and statuses' refresh frequency are customizable.

6. station or standing post which the involved emergency resource belongs to

7. icon representing the possible presence of notes the operator might have been taking down during either call taking or dispatching phase (or both). An operator is granted the possibility to open emma embedded notepad during any phase of emergency management process.

8. icon representing the possible messages (e.g. radio messages or SMS) that the PSAP Operator might have sent to first responders within the tracking phase. The icon carries the information of the status of the message dispatching (in queue, sent, delivery acknowledged).

9. color code (e.g., red, yellow, green, white) assigned by first responders on the field

10. in EMS application, color code (e.g., red, yellow, green, white) assigned by the receiving hospital ER

11. icon representing a particular component of the crew on board the emergency vehicle (e.g. a doctor in an ambulance)

12. accounting information about the dispatched vehicle (should it be property of a third party providing emergency resources to the PSAP? (e.g., ambulances might be provided by Charities.))

13. a warning icon suggesting that dispatch record is lacking some important tracking information or that conflicting information has been filled in (e.g., conflicting timestamps)

Directly from the dashboard, the following functions and features are available to do the process (as one embodiment):

1. Open the selected incident record or the selected dispatch record

2. Print the selected incident record or the selected dispatch record

3. Execute a filtered search among all the incidents and dispatches

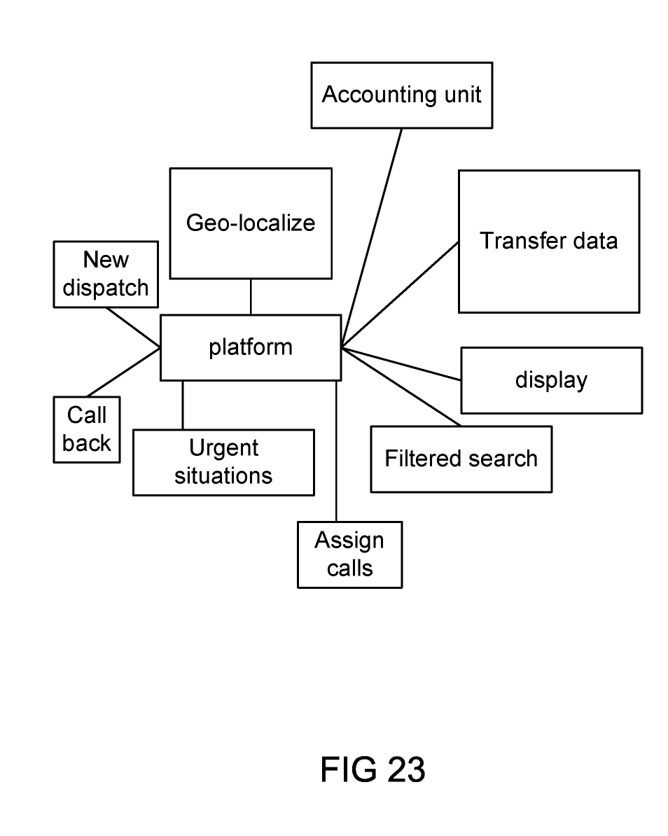

4. Geo-localize the incident on the GIS display (See, e.g., FIG. 23.)

5. Geo-localize on the field emergency resources on the GIS display

6. Transfer the incident record to another PSAP (e.g., via CAP protocol, email, or any other web services based protocol)

7. Display the synthesis of all alerted stations, precincts, or standing posts

8. Associate an incoming or outgoing call to the particular incident. In this way, emma inputs the call logger to mark the audio file of the recorded call with the incident unique ID.

9. Call back the caller

10. Create new dispatches for the selected event

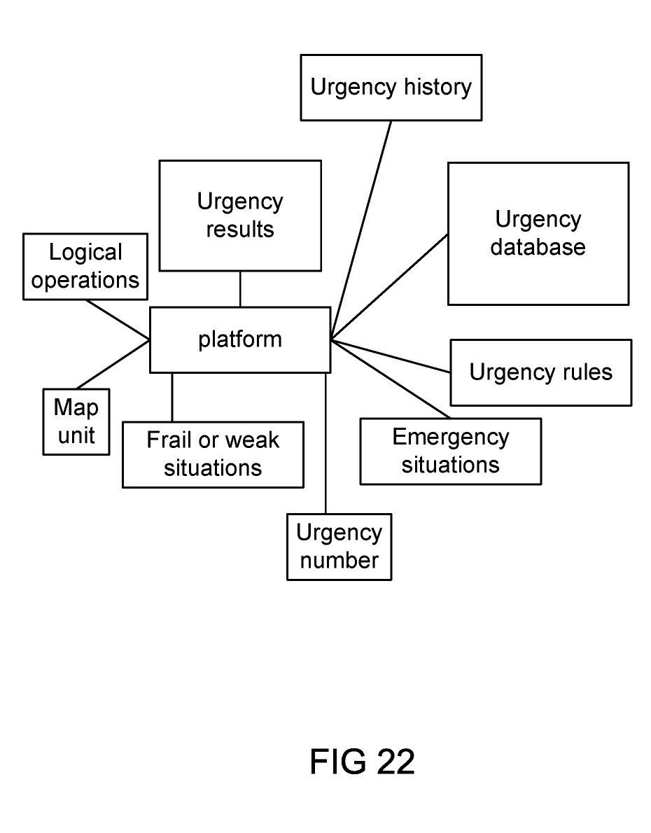

11. Search all the inventoried “frail” patients within a configurable radius from an occurring incident. This is typically used in case of major crisis (e.g., big blasts, floods, earthquakes) in order for the PSAP to proactively take care of such classes of citizens, first, or in priority, or in order of urgency, as they can be marked or graded based on the urgency of patients, e.g., using scores 1 to 100 or fuzzy values, e.g., low urgency, mid-urgency, and high-urgency. (See, e.g., FIG. 22.)

In one embodiment, the dashboard itself can be used as a read-only at a glance picture of the ongoing recent incidents and dispatches for the use of PSAP supervisors or for remote Agencies that may be concerned on emergency-related occurrences within the area of jurisdiction (e.g., hospitals, local or federal offices). Such “read-only” accesses are possible via a simple web browser.

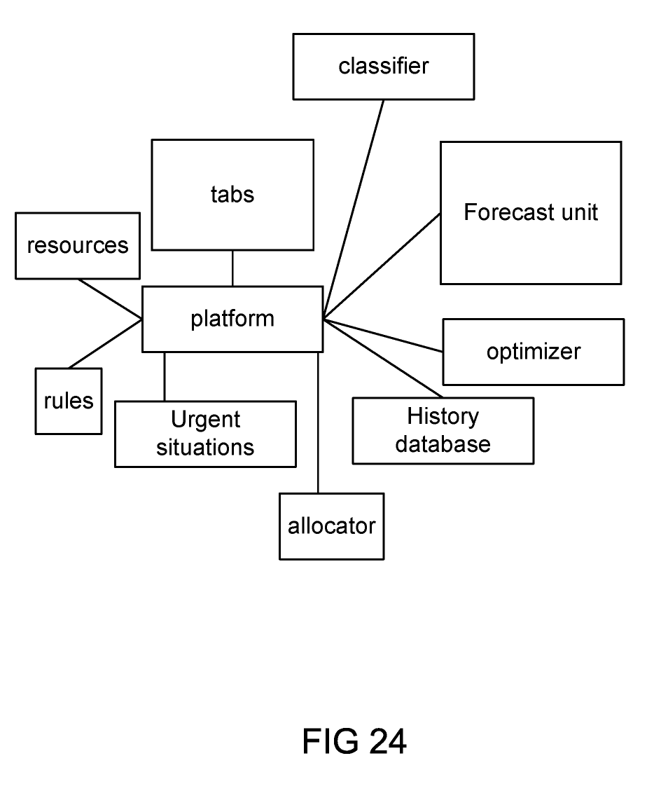

In one embodiment, the dashboard can be provided with different “tabs”, each of them filtering the displayed incidents and related dispatches on the basis of any relevant details, for example on the basis of the incident classification (e.g., Police, Fire, EMS, Major Crisis), on the basis of the incident code (e.g. red code, yellow code), on the basis of a specific geographical area, etc. (See, e.g., FIG. 24.)

In one embodiment, the filter is applicable on a per user fashion, in a way that the dashboard of the same PSAP could be displayed with no filter to the PSAP supervisors, and, for example, with EMS-only incidents towards local hospitals. Depending on the PSAP requirements, a light version of the dashboard can also be displayed which encompasses a set of the aforementioned incident and dispatch details.

In one embodiment, we have a system for analyzing and prediction for event management, which has:

a user interface;

a display monitor;

a first analyzer module for analyzing historical data to find trends and patterns;

a feeding module for receiving real time data for traffic and weather;

a first database for results of historical events;

a dispatcher module;

a first map module for roads;

a second map module for weather;

a third map module for traffic;

a predictor for total travel time calculation;

a map analyzer for making routes in small pieces for time calculation summation;

a resource analyzer for marking and locating resources;

a re-assigner module to re-allocate the resources in real time; and

a main database for storing results. (See figures above.)

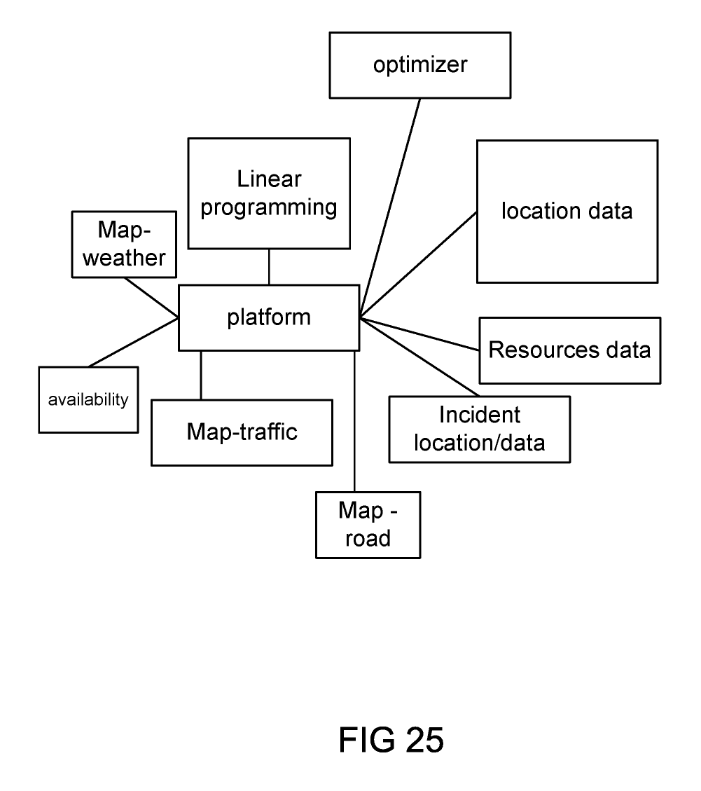

In one embodiment, we have an emergency vehicles location dynamic prediction, a tool to dynamically forecast the optimal emergency vehicles positioning, balancing time responsiveness and the actual number of available resources on the ground. This prediction and dynamically forecasting, as well as optimal emergency vehicles positioning, or balancing time responsiveness, based on the actual number of available resources on the ground, all are very important to allocate the resources in real time or in advance, to maximize the efficiency of people, experts, equipment, and vehicles, as well as increased availability, reduced time to the destination, reduced personnel needed, reduced damages, reduced fatalities, and reduced cost of operation. So, we can make the clients very efficient and satisfied, which is unique in our system. (See, e.g., FIG. 25.)

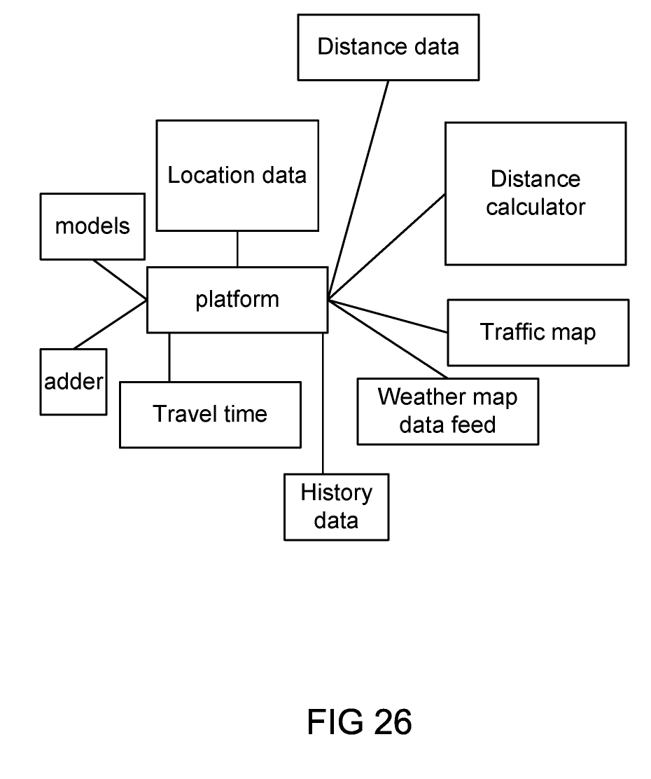

In one embodiment, we have a system for linear programming or other methods, to optimize function Fᵢ, for the location of vehicles Vᵢ and personnel Pᵢ, with respect to the incidents Iᵢ, patients Aᵢ, accident locations Lᵢ, and disaster location Dᵢ, plus the degree of urgency for each Uᵢ, plus location of final transportation Tᵢ, e.g. nearest hospital to be able to help with that specialty. In addition, the traffic map Mᵢ and weather map M_{w} are also helpful to estimate the travel times through various routes and methods, e.g., using the highways, or using medical helicopter. These can be updated on a real-time basis. So, the nearest hospital or nearest ambulance may not be the best solution for a given set of emergency situations simultaneously happening in an area. (See, e.g., FIG. 26.)

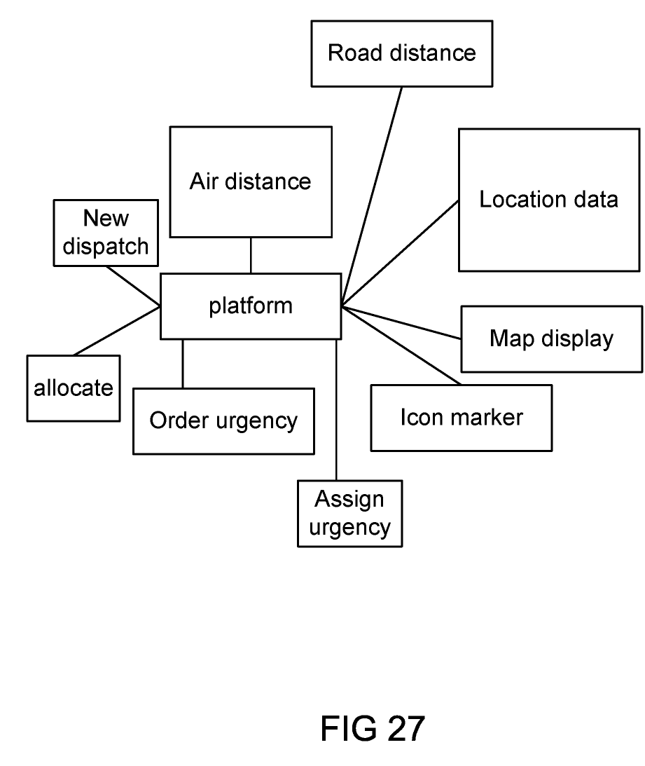

If we treat these locations as a vector or set of numbers for 3-D or 2-D coordinate of an object, then we can find the relative distances/locations, as follows, as an example, for travel over air distance, e.g. for helicopters: (See, e.g., FIG. 27.)

Vᵢ−Iᵢ, vehicle to incident distance

Pᵢ−Aᵢ, personnel to patient distance

Lᵢ−Tᵢ, accident to hospital distance

Dᵢ−Tᵢ, disaster to hospital distance

Of course, for road distance, the actual distance from map or database is used, (Vᵢ−Iᵢ)_{Road} which is larger than air distance, with the factors of traffic map Mᵢ and weather map M_{w} being used to find the time of travel Tᵢ. This can be based on models, formulas, prior experiences, history, or tables, estimating such times for different situations, e.g.:

Tₜ=Function((Vᵢ−Iᵢ)_{Road},Mₜ,M_{w})

For an accident, if the urgency factor or score is high, e.g. urgent situation, e.g., 90 out of 100, max value, then we can order the numbers associated with the urgency values, in a decreasing order, for all accidents within our area, and get, e.g., a sequence of accident numbers, in the order of urgency:

accident numbers={Accident₄, Accident₂, Accident₈, . . . }

With urgency values, respectively, in order, for the above set:

Uᵢ={90, 85, 64, . . . }

So, e.g., the system starts from Accident₄, as a loop to the end of the list and continues the loop, and calculates the corresponding values for Tₜ for corresponding hospitals with eligible expertise, with respect to a given accident, Accident₄, for resources of personnel and vehicles, e.g., helicopters or fire fighters, to find the min value for Tₜ, which corresponds to the best method to help for that accident or incident. Once the resources are dispatched for one accident, they become unavailable, and get eliminated from available set of resources, e.g., ambulances. Then, the system repeats the same loop and continues with then-current set of resources/experts and accidents, plus hospitals, etc.

One example of finding Tₜ for corresponding routes is by collection of piecewise road stretches that make the point A to B connected, in which the time for each piece is simply added to get the total time, for point A to B. These are based on historical data from many days for the same time, season, and weather conditions, averaged or aggregated for many days, or by looking for distribution of values on, e.g., the Normal distribution curve, e.g., to get the median value from the curve, as the “time”, as an example.

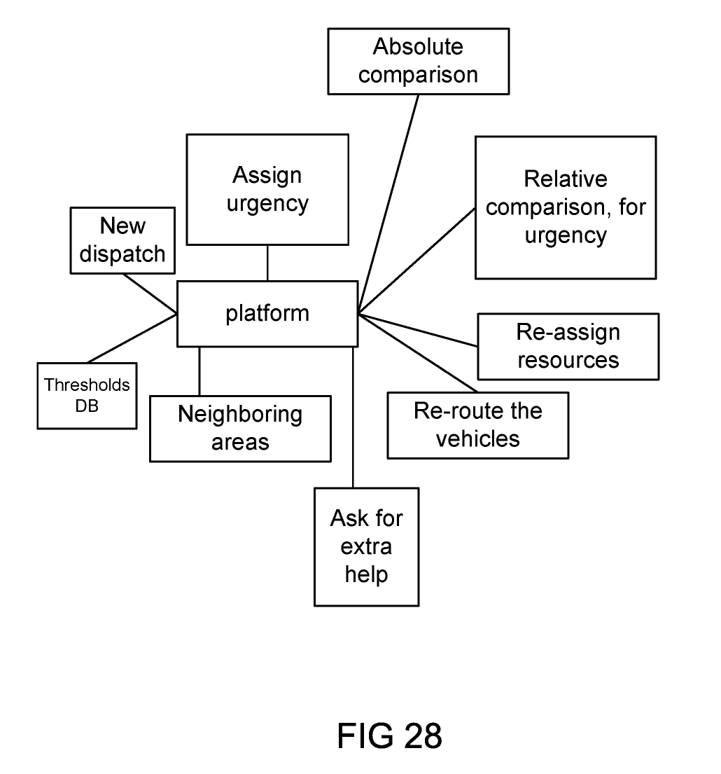

A new situation happens when, e.g., the medium priority situation of 64 urgency score (e.g., a minor traffic accident) is the highest member of the priority list/set, Uᵢ, at a given point, and an ambulance Aₘ, e.g., is responding to that accident. However, during dispatching and going toward that minor accident, a new more serious accident happens, with near fatalities, which requires more immediate attention, with urgency of 99, out of 100, max value. In that case, the difference between (Uᵢ−Uⱼ) is so large (i.e., (99−64)=35, which is beyond a first threshold of 10 points, e.g.), or using ((Uᵢ−Uⱼ) for relative difference (i.e., (35/64), which is bigger than a 2nd threshold 0.5, e.g.), that the nearest ambulance in terms of time must be dispatched immediately. (See, e.g., FIG. 28.) In this example, other ambulances are too far, and the nearest one is the very same ambulance Aₘ. Thus, ambulance Aₘ goes to the new accident with higher urgency factor or score, and a new ambulance is dispatched to the old accident, with lower urgency factor or score, Uᵢ, which repeats the same loop above, to find the new ambulance, with remaining resources and accidents in the area, in the sets/lists. Thus, the urgency factor can tilt/replace/re-order the allocation of the resources, to save lives, as an example, as shown above.

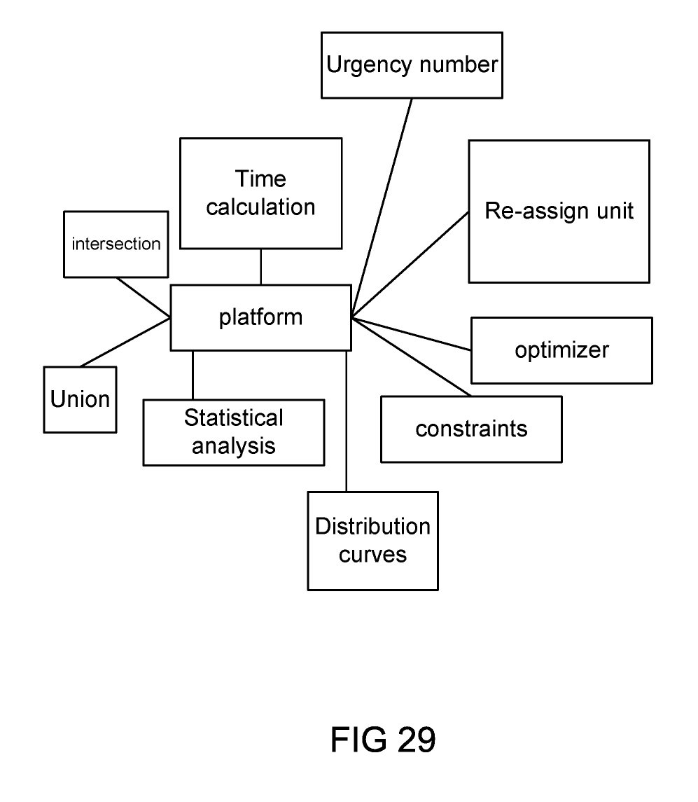

In addition, one area, having surplus of resources at a given time, can help the neighboring state or city or region, for emergency situations, such as flood. So, optimization between neighboring regions as a whole is very important for overall efficiency and rescue efforts. Thus, we get the union U and/or intersection A of the sets/lists for these operations. For example, the union of set of, e.g., available hospitals Hᵢ is found to expand the reach from neighboring area (Hᵢ U Hⱼ), and the intersection is found of available multiple expertise skills that are needed for a given surgery, e.g., multiple doctors and nurses (Nᵢ) are needed for a given surgery (Nᵢ [symbol] Nₐ). (See, e.g., FIG. 29.)

### Method and System for Platform for Event Management:

### The Tavolo™

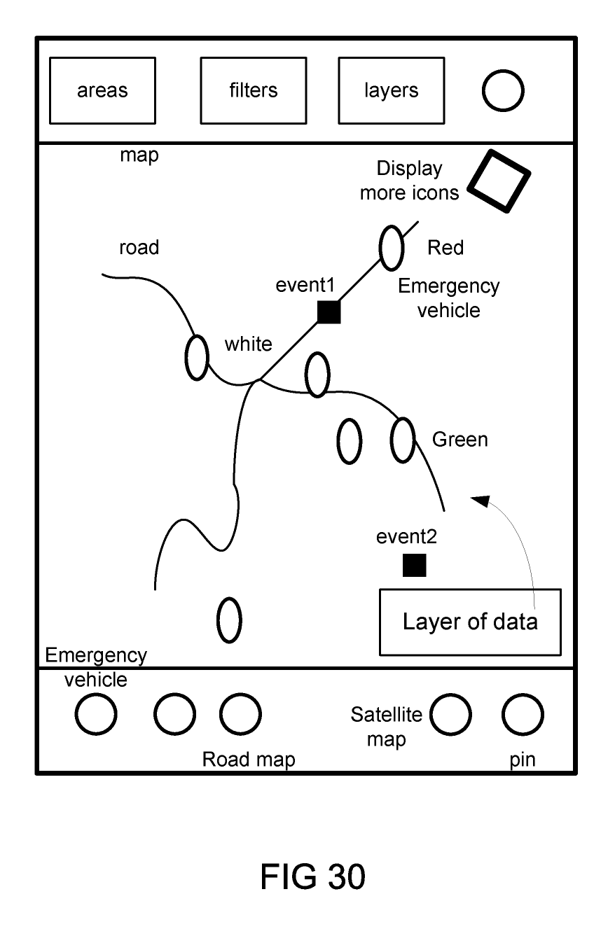

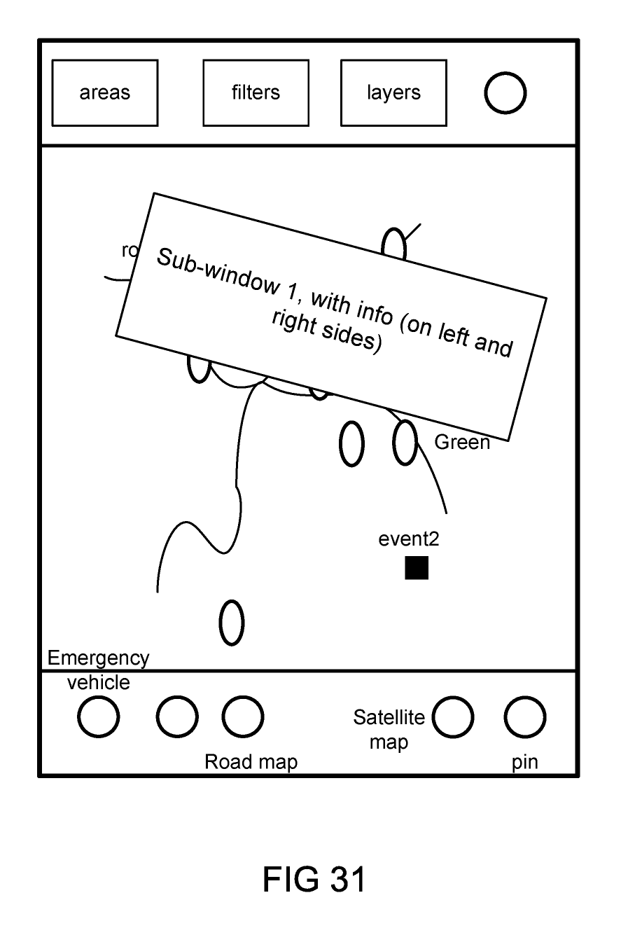

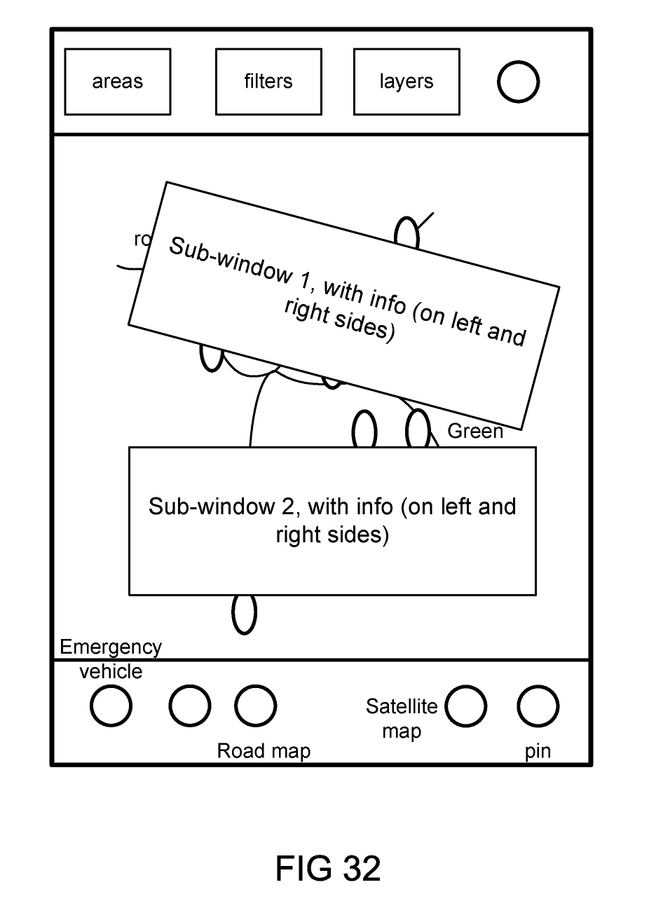

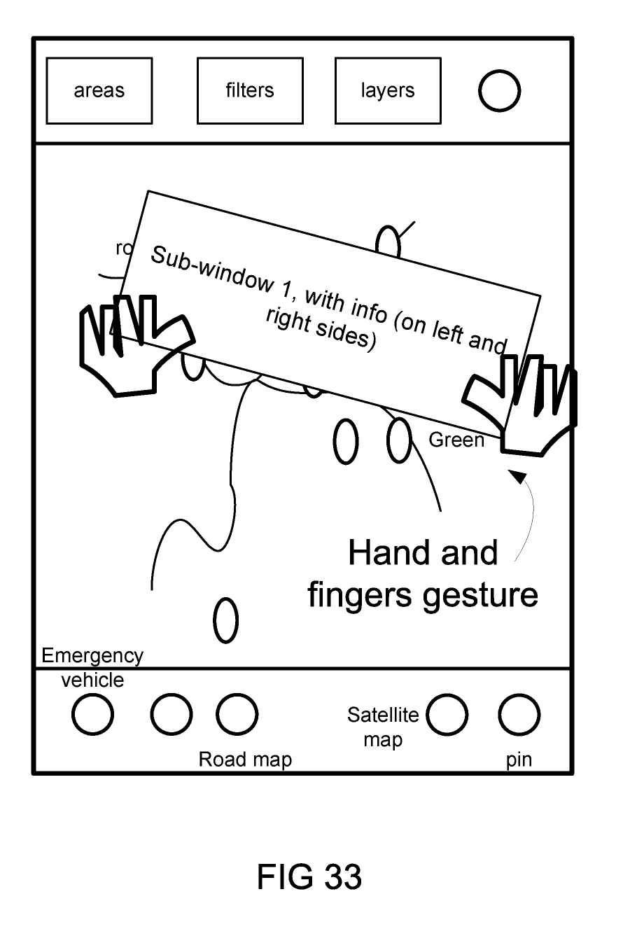

FIG. 30 is for one embodiment, as an example, for our platform and device, with various buttons and functions, plus display and options. FIG. 31 is for one embodiment, as an example, for our platform and device, with one sub-window. FIG. 32 is for one embodiment, as an example, for our platform and device, with multiple sub-windows. FIG. 33 is for one embodiment, as an example, for our platform and device, with hand and finger gestures for user input.

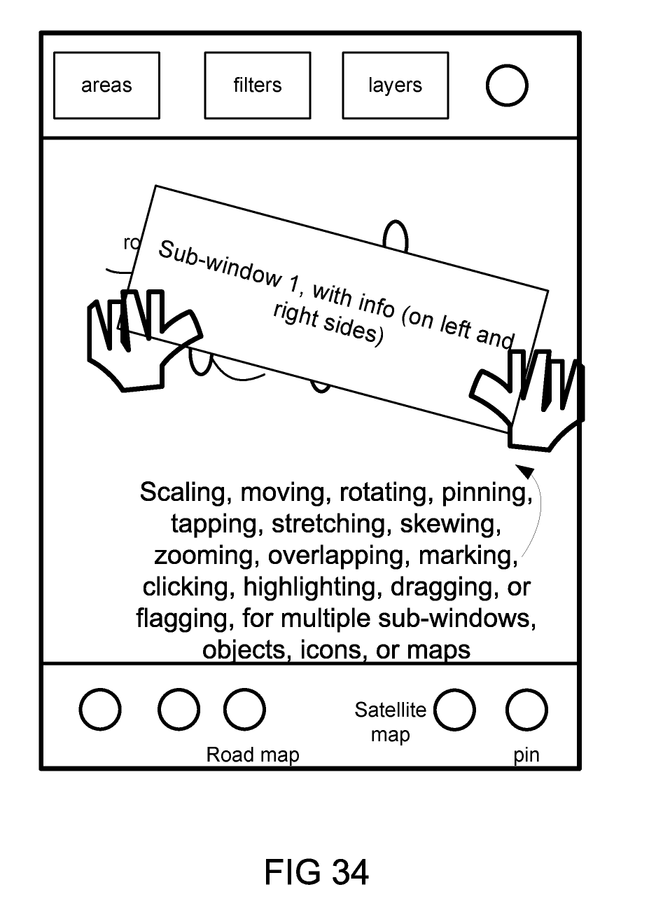

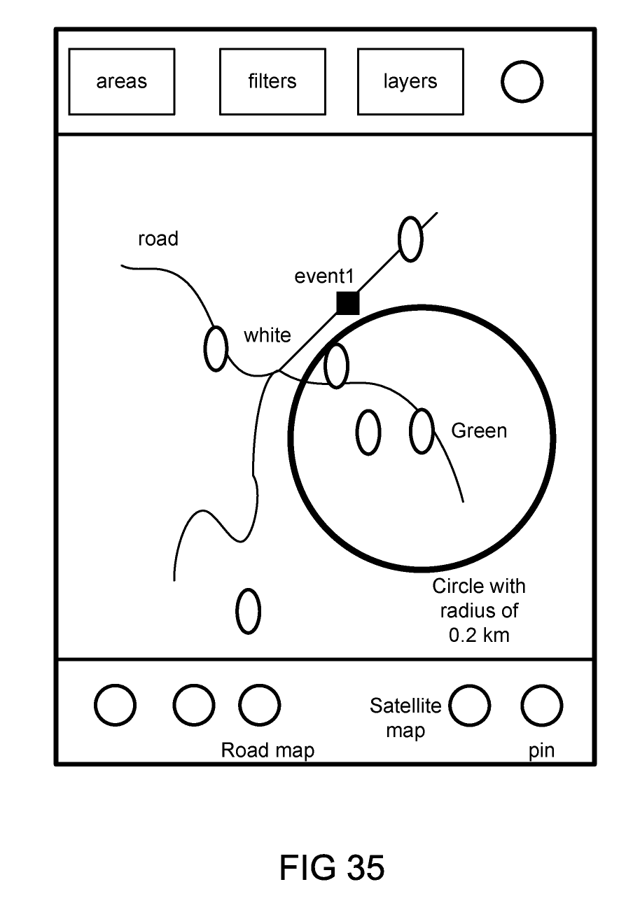

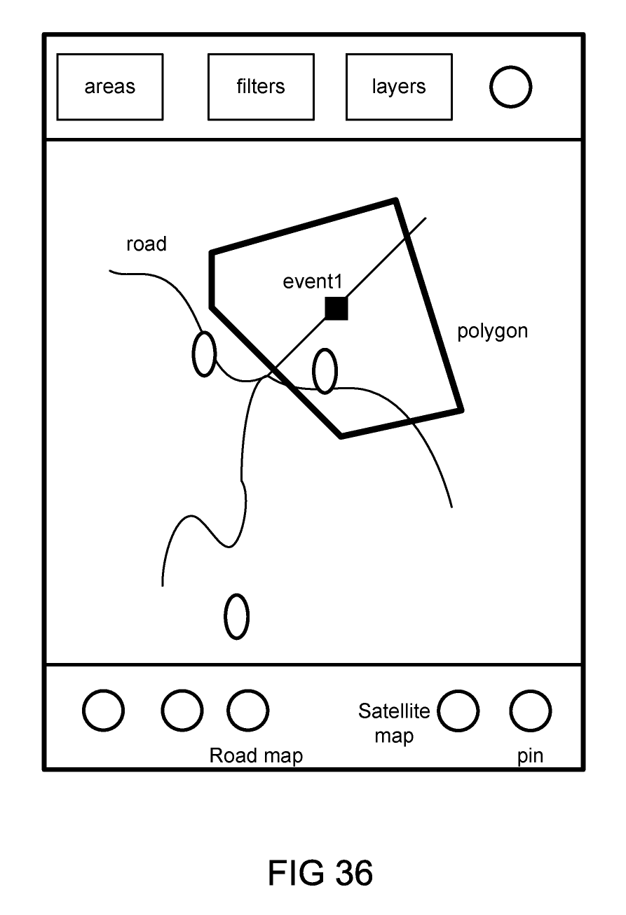

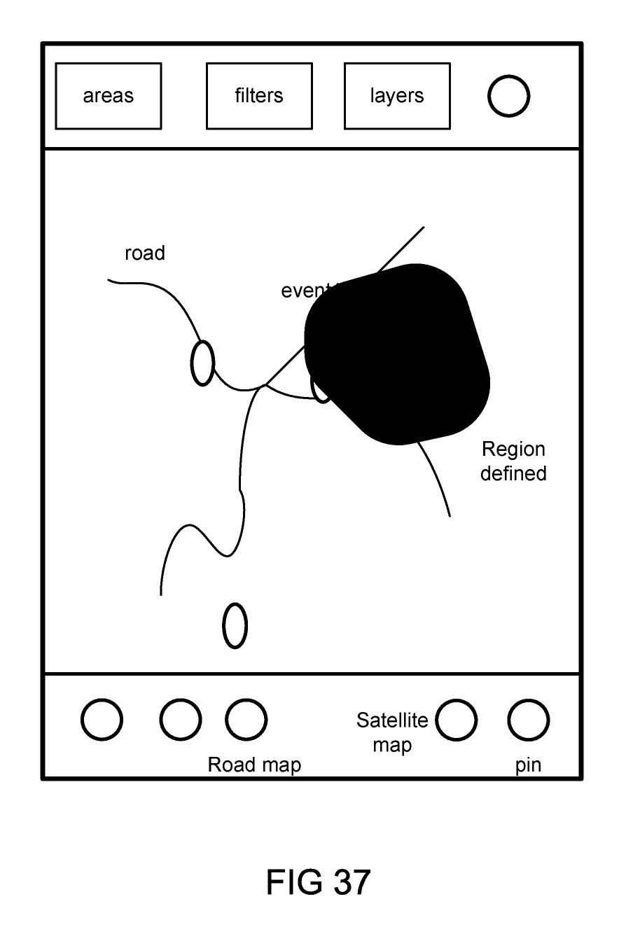

FIG. 34 is for one embodiment, as an example, for our platform and device, with various functionalities on the screen. FIG. 35 is for one embodiment, as an example, for our platform and device, with a circle region defined on screen. FIG. 36 is for one embodiment, as an example, for our platform and device, with a polygon region defined on screen. FIG. 37 is for one embodiment, as an example, for our platform and device, with a region defined on screen.

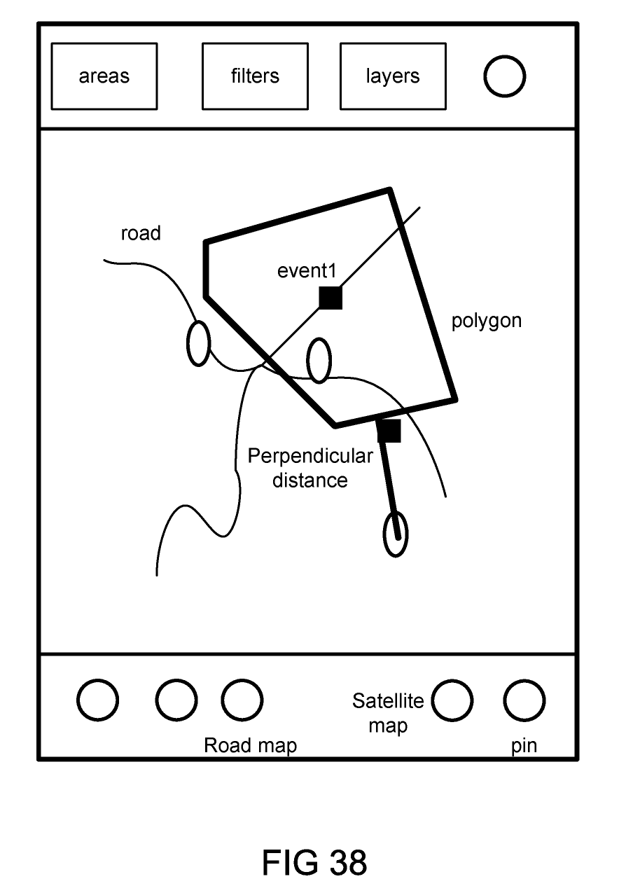

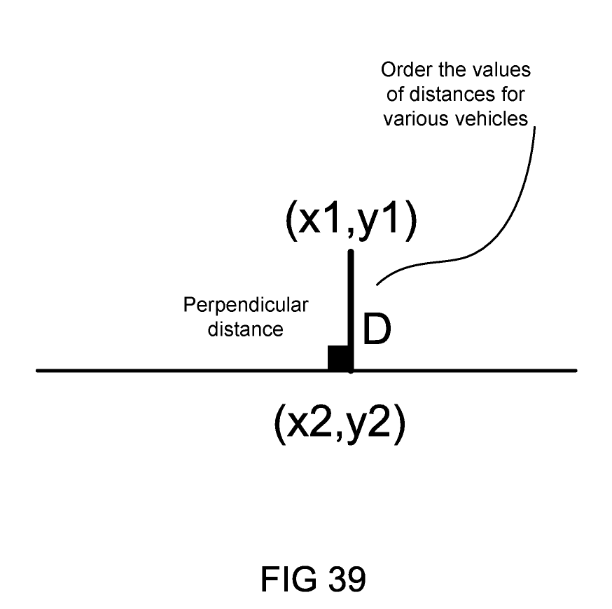

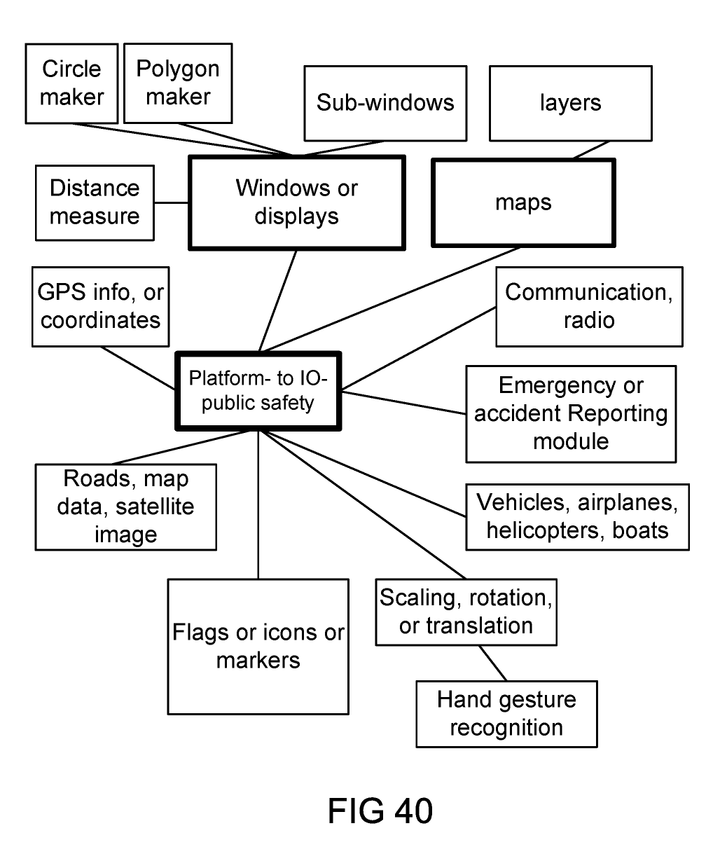

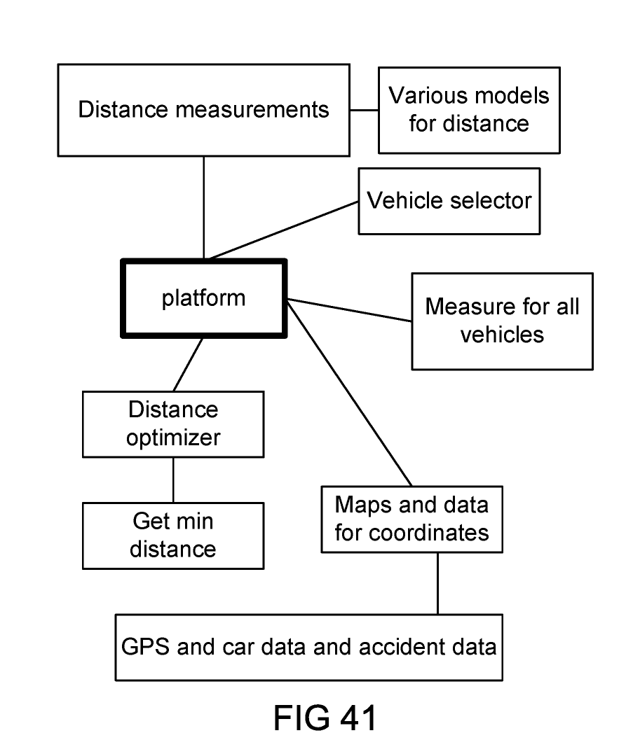

FIG. 38 is for one embodiment, as an example, for our platform and device, with a perpendicular distance measured on screen. FIG. 39 is for one embodiment, as an example, for our platform and device, with a perpendicular distance measured and ordered for various vehicles. FIG. 40 is for one embodiment, as an example, for our system, with components of our platform for public safety. FIG. 41 is for one embodiment, as an example, for our platform and system, with distance optimizer.

Here, we have an example: A platform system for analyzing and prediction for event management, said platform system comprising: a user interface; a display monitor; said display monitor has a touch-screen input device; wherein a user's hand's or finger's gestures are captured by said touch-screen input device; a processor; wherein said processor interprets said captured user's hand's or finger's gestures to one or more functions on said platform system; said user interface comprises a filter module, a layer module, and an alert module; said processor creates one or more sub-windows on top a main window on said display monitor; a circle maker tool; a polygon maker tool; wherein said circle maker tool specifies a circle on a map shown on said display monitor, with length of radius of said circle measured and displayed on said display monitor; wherein said polygon maker tool specifies a region on said map shown on said display monitor; wherein said map specifies location of emergency vehicles, availability of said emergency vehicles, location of an event, degree of urgency and type of said event, and coordinates of roads and buildings; an event manager; wherein said event manager coordinates available resources against said event; with the following optional features:

an antenna and a communication device.

an analyzer module for analyzing historical data to find trends and patterns.

a dispatcher module.

a resource analyzer for marking and locating resources.

a command and control module.

a call tracking module.

a coordination optimizer module.

a flag maker.

an icon maker.

a marker maker.

a GPS module.

a distance measurement module.

a distance minimization module.

a distance optimization module.

a map layers module.

a feature filter module.

a distance model calculation module.

a pin specification module.

a satellite map module.

Here, we have the Application Layer for Public Safety Answering Points, or The Tavolo Public Safety app, or The Tavolo platform, which is also described in video, on Youtube, at the following site, where one can find the main functionalities of the system, as well as various features:

https://www.youtube.com/watch?v=lO3FLEec3fc

(Marked as: The Tavolo™ Demo, by BETA80GROUP)

The following is a textual description of the above video:

“The Tavolo™” is a multi-touch screen table for PSAPs and emergency operation centers. It can display live events, dispatches, and real-time information, and it can be integrated with any CAD system.

Important Features:

To start, click on “layers” option or button, and we get several types of maps that we can choose from.

Select the type of the map layer.

Now, select filters.

See all the resources and events in the real-time.

Dispatch center managers get all the information, e.g., current events and vehicles, as well as the corresponding tags, points of interests, sensors, and cameras.

It can have as many filters for sub-categories that you need.

First, select only the Events.

It shows only all the events that are active in the CAD system.

For more details on an event, click on the exclamation mark, and the details will pop up on screen, on a separate window, as a sub-window, on top of the old one, or original or main window.

It can move or scale the 2nd window or sub-window on top of the first or main window, as the user wishes, by user's hand's or finger's motions or gestures.

Once the location is set, pin the window, before doing the next step or action.

Event window tells us the event classification and its exact location, plus contact details and Google street view.

For further information, select one of the icons at the corner of screen:

First icon shows: which resources are assigned to the situation/event.

Use vehicle filter, to see them on the map.

2nd icon: center that event on the map.

3rd icon: shows availability of resources, as to what resources we can reach right now.

Then, pin it.

To send vehicle to the event, just drag and drop an available vehicle to the bottom region of the 2nd sub-window in the main window.

Push “Send Vehicles” button or flag or symbol.

Then, for the next function:

Close windows.

Check vehicle filters:

It shows all the vehicles active in the CAD system.

If the icon is not white (but has green, yellow, or red color), then it means that the vehicle is already assigned to an event.

For more details about the vehicle, choose the vehicle on the map and the details will pop up on a sub-window, located over the main window.

On the left side of the sub-window on the main window, we have event details, where the vehicle is heading to.

On the right side of the sub-window on the main window, we have vehicle details, such as coded response, organization, dispatch ID, and the like.

Two new icons on the corner of the sub-window on the main window:
Phone icon
Walkie talkie icon

These are used to contact the vehicle directly from the table. It has integrated communication system, as well, e.g., using radio.

By selecting the icon on the map, and by using any filter sub-category, we get more information.

Then, for the next function:

To get the overview of the situation, for the whole system, town, site, or region, we zoom in an area, by using hand gesture on the window, to look at a specific area (the event area).

Then, for the next function:

For Actions:

We can select “Free Form Selection Tool”:

Use this tool to select the critical area. Click on the corner points of a polygon, to draw the polygon region and highlight the inner color of the polygon on screen for users to see.

To cancel the selection, just click on the Hand icon on the bottom.

Another option: Circular Selection Tool:

Drag the point on screen: It selects the critical area, and also, it calculates the radius distance from the event.

So, we have now selected our perimeter control.

Then, we can dispatch our vehicle(s) and coordinate the responses.

Then, for the next function:

On the bottom, it shows the number of new incidences coming in, e.g., 78.

In summary, we have a platform for public safety. It can independently run, or integrated with existing system (a third party's CAD system). It gives a holistic view of all operations across all agencies and across the region. It increases the operational efficiency and enhances public safety effectiveness and accuracy. (It also has an alert function on the screen.)

As an example of the optimization for our system, using the polygon region, let's assume that we have highlighted a region (with our polygon tool on the map) which includes the event location on the map, roughly at the center of the polygon. Thus, all of the corners of polygon have exact and known coordinates, stored in our system. Now, if we have one or more available vehicles in the vicinity, we can use the following algorithm, as an example, to automatically call the best choice for an available vehicle (e.g., if the user or manager is not available to choose the vehicle, manually):

In one example, if the available emergency vehicle (with the right color designation on the map) is within the polygon region, then that vehicle is selected for response, and is dispatched by the manager. If there is no available emergency vehicle within the polygon region, then the distance of a given vehicle to the boundaries/sides of polygon is calculated, as shown in FIGS. 38-39. Then, the minimum distance among all distances/values is found for a given vehicle. Then, the minimum distance for all vehicles is found, which corresponds to the vehicle that we want to dispatch to the event.

The only exception to this rule is that a new event pops up immediately, which calls the same vehicle and is closer to that vehicle, which trumps the old designation, and the selection restarts again from scratch, minus the selected vehicle for the new event. This loop and algorithm can continue until a vehicle is selected for the original event. The distance is the vertical distance from a point to the side of polygon, as shown in FIGS. 38-39, which is calculated as the following square root value (see FIG. 39):

D=√((x2−x1)²+(y2−y1)²)

Also, alternatively, we can find the distance by going on the Google map or similar maps, to find the actual street map, on the streets selected/optimized by the map, between the 2 points, for actual mileage distance. This of course takes longer time than the calculation above, to find the vehicle. So, the method above may be preferable for faster response, unless we have enough CPU for fast calculations. A human/user can find/assign the vehicle as well, as a backup.

Any variations of the above teaching are also intended to be covered by this patent application.

1. A platform system for analyzing and prediction for event management, said platform system comprising:
a user interface;
a display monitor;
said display monitor has a touch-screen input device;
wherein a user's hand's or finger's gestures are captured by said touch-screen input device;
a processor;
wherein said processor interprets said captured user's hand's or finger's gestures to one or more functions on said platform system;
said user interface comprises a filter module, a layer module, and an alert module;
said processor creates one or more sub-windows on top a main window on said display monitor;
a circle maker tool;
a polygon maker tool;
wherein said circle maker tool specifies a circle on a map shown on said display monitor, with length of radius of said circle measured and displayed on said display monitor;
wherein said polygon maker tool specifies a region on said map shown on said display monitor;
wherein said map specifies location of emergency vehicles, availability of said emergency vehicles, location of an event, degree of urgency and type of said event, and coordinates of roads and buildings;
an event manager;
wherein said event manager coordinates available resources against said event.

2. The platform system for analyzing and prediction for event management, as recited in claim 1, said platform system comprising:
an antenna and a communication device.

3. The platform system for analyzing and prediction for event management, as recited in claim 1, said platform system comprising:
an analyzer module for analyzing historical data to find trends and patterns.

4. The platform system for analyzing and prediction for event management, as recited in claim 1, said platform system comprising:
a dispatcher module.

5. The platform system for analyzing and prediction for event management, as recited in claim 1, said platform system comprising:
a resource analyzer for marking and locating resources.

6. The platform system for analyzing and prediction for event management, as recited in claim 1, said platform system comprising:
a command and control module.

7. The platform system for analyzing and prediction for event management, as recited in claim 1, said platform system comprising:
a call tracking module.

8. The platform system for analyzing and prediction for event management, as recited in claim 1, said platform system comprising:
a coordination optimizer module.

9. The platform system for analyzing and prediction for event management, as recited in claim 1, said platform system comprising:
a flag maker.

10. The platform system for analyzing and prediction for event management, as recited in claim 1, said platform system comprising:
an icon maker.

11. The platform system for analyzing and prediction for event management, as recited in claim 1, said platform system comprising:
a marker maker.

12. The platform system for analyzing and prediction for event management, as recited in claim 1, said platform system comprising:
a GPS module.

13. The platform system for analyzing and prediction for event management, as recited in claim 1, said platform system comprising:
a distance measurement module.

14. The platform system for analyzing and prediction for event management, as recited in claim 1, said platform system comprising:
a distance minimization module.

15. The platform system for analyzing and prediction for event management, as recited in claim 1, said platform system comprising:
a distance optimization module.

16. The platform system for analyzing and prediction for event management, as recited in claim 1, said platform system comprising:
a map layers module.

17. The platform system for analyzing and prediction for event management, as recited in claim 1, said platform system comprising:
a feature filter module.

18. The platform system for analyzing and prediction for event management, as recited in claim 1, said platform system comprising:
a distance model calculation module.

19. The platform system for analyzing and prediction for event management, as recited in claim 1, said platform system comprising:
a pin specification module.

20. The platform system for analyzing and prediction for event management, as recited in claim 1, said platform system comprising:
a satellite map module.
